(19) United States
(12) Patent Application Publication
(10) Pub. No.: US 2010/0156959 A1
(43) Pub. Date: Jun. 24, 2010

(54) Lighting apparatus and method, display apparatus and method, and program

(75) Inventor: Makoto TANAHASHI, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/653,772

(22) Filed: Dec. 17, 2009

(30) Foreign Application Priority Data
Dec. 24, 2008 (JP) P2008-326994

(51) Int. Cl. G09G 5/10; H05B 37/02

(52) U.S. Cl. 345/690; 315/294

(57) ABSTRACT

A lighting apparatus includes: a first light source having a predetermined chromaticity in a chromaticity diagram and an emission luminance which varies according to a current; a second light source configured in such a way that a line connecting the chromaticity of the first light source and that of the second light source passes a part of a black body curve, and having an emission luminance which varies according to a current; a light guide plate that outputs lights from the first and second light sources in a predetermined direction; and a light source drive section that fixes a current of one of the first and second light sources and variably controls a current of the other one of the first and second light source according to a target value of a chromaticity of a combined light of the lights output from the light guide plate.

### BACKGROUND OF THE INVENTION

1. Field of the Invention

The present invention relates to a lighting apparatus and method, a display apparatus and method, and a program, and, more particularly, to a lighting apparatus and method, a display apparatus and method, and a program, which can make the luminance adjustment range of a display apparatus wider than before.

2. Description of the Related Art

Recently, liquid crystal display apparatuses are becoming popular. A liquid crystal display apparatus controls the transmission of light incident to its liquid crystal panel to display an image. Therefore, a back light device as a lighting apparatus which inputs light to the liquid crystal panel is installed therein.

While the light source of a back light device is often a single cold-cathode tube (hereinafter called “lamp”) in a notebook type personal computer or the like, it often includes a plurality of lamps in a desktop type personal computer, television set or the like (see JP-A-11-174976 (Patent Document 1), JP-A-9-292614 (Patent Document 2), JP-A-8-286184 (Patent Document 3), and JP-A-2001-351425 (Patent Document 4)).

In a liquid crystal display apparatus, the chromaticity (chromaticity coordinate) of light emitted from the lamp of a back light device is determined in accordance with the target chromaticity (target value of the chromaticity coordinate) of light output from the liquid crystal panel. In other words, for example, when it is intended to output light having a chromaticity with a color temperature of 6500 degrees or 9300 degrees from the liquid crystal panel (when the target value is the chromaticity coordinate of a chromaticity (point) corresponding to 6500 degrees or 9300 degrees on a black body curve in a chromaticity diagram), the lamp is made as follows. To provide a target chromaticity on the liquid crystal surface of the liquid crystal panel, the phosphor is dispensed in consideration of and the lamp is manufactured to cope with a chromaticity change or the like originated from color attenuation caused between the lamp and the liquid crystal panel. In short, the dispensing type of the phosphor is set according to the target chromaticity.

As apparent from the above, the chromaticity of light from a lamp is generally fixed. That is, a lamp is made so as to fix the chromaticity.

According to the related arts disclosed in Patent Documents 1 to 4, the following difficulty is pointed out when the condition is changed, specifically, when the current of a lamp is changed due to luminance adjustment or the like, when the phosphor in the lamp is degraded with the time, or when the ambient temperature of the lamp is changed. It is difficult to hold both of the luminances and the chromaticity coordinates of the chromaticities of lights input from a plurality of lamps and output from the light guide plate to target values (which may be fixed values or variables on the assumption of their adjustment or the like).

A back light device which can overcome the shortcoming has been devised by the present inventor and is disclosed in JP-A-2005-166583 (Patent Document 5).

### SUMMARY OF THE INVENTION

However, the back light device described in Patent Document 5 has a difficult to fulfill the demand of widening the luminance adjustment range of the display apparatus.

The present invention therefore addresses such a situation to make the luminance adjustment range of the display apparatus wider than the one achieved by the related arts.

According to an embodiment of the present invention, there is provided a lighting apparatus including a first light source having a predetermined chromaticity in a chromaticity diagram and an emission luminance which varies according to a current, a second light source configured in such a way that a line connecting the chromaticity of the first light source and a chromaticity of the second light source in the chromaticity diagram passes a part of a black body curve, and having an emission luminance which varies according to a current, a light guide plate that outputs lights from the first light source and the second light source in a predetermined direction, and a light source drive section that fixes a current of one of the first light source and the second light source and variably controls a current of the other one of the first light source and the second light source according to a target value of a chromaticity of a combined light of the lights output from the light guide plate.

Each of the first light source and the second light source may be configured to include a lamp.

The first light source may be configured to include a lamp formed of a blue phosphor.

The second light source may be configured to include a lamp formed of a green phosphor and a red phosphor.

The light source drive section may fix the current of one of the first light source and the second light source, and change the current of the other one of the first light source and the second light source.

The light source drive section may fix the current of the second light source, and variably control the current of the first light source.

The light source drive section may control the currents of the first light source and the second light source so as to become a predetermined level when a predetermined color coordinate is set as a target value within a range of color coordinates settable as a target value of the chromaticity, fix the current of one of the first light source and the second light source to the predetermined level, and variably control the current of the other one of the first light source and the second light source in a range lower than the predetermined level, when a color coordinate lower than the predetermined color coordinate is set as the target value, and variably control the current of the one of the first light source and the second light source in a range lower than the predetermined level, and fix the current of the other one of the first light source and the second light source to the predetermined level, when a color coordinate higher than the predetermined color coordinate is set as the target value.

The line connecting the chromaticity of the first light source and chromaticity of the second light source in the chromaticity diagram may pass a color temperature of 6500K in the chromaticity diagram or within a predetermined range.

The first light source may include an LED (Light Emitting Diode) having a blue semiconductor chip, and the second light source may include an LED having a phosphor applied to a blue semiconductor chip to emit light.

According to one embodiment of the present invention, there are provided a lighting method and program which corresponds to the lighting apparatus according to the aforementioned embodiment.

According to the lighting apparatus, lighting method and program according to the embodiment, the lighting apparatus including a first light source having a predetermined chromaticity in a chromaticity diagram and an emission luminance varying according to a current, a second light source configured in such a way that a line connecting the chromaticity of the first light source and a chromaticity of the second light source in the chromaticity diagram passes a part of a black body curve, and having an emission luminance which varies according to a current, and a light guide plate outputting lights from the first light source and the second light source in a predetermined direction, is allowed to drive the first light source and the second light source and to fix a current of one of the first light source and the second light source and variably control a current of the other one of the first light source and the second light source according to a target value of a chromaticity of a combined light of the lights output from the light guide plate.

According to another embodiment of the invention, there is provided a display apparatus including a first light source having a predetermined chromaticity in a chromaticity diagram and an emission luminance which varies according to a current, a second light source configured in such a way that a line connecting the chromaticity of the first light source and a chromaticity of the second light source in the chromaticity diagram passes a part of a black body curve, and having an emission luminance which varies according to a current, a light guide plate that outputs lights from the first light source and the second light source in a predetermined direction, a display panel that uses the lights incoming from the light guide plate to display an image, and a light source drive section that drives the first light source and the second light source and fixes a current of one of the first light source and the second light source and variably controls a current of the other one of the first light source and the second light source according to a target value of a chromaticity of a combined light of the lights output from the light guide plate.

According to another embodiment of the present invention, there are provided a display method and program which are compatible with the display apparatus according to the aforementioned another embodiment.

According to the display apparatus, display method and program according to the another embodiment, the display apparatus including a first light source having a predetermined chromaticity in a chromaticity diagram and an emission luminance varying according to a current, a second light source configured in such a way that a line connecting the chromaticity of the first light source and a chromaticity of the second light source in the chromaticity diagram passes a part of a black body curve, and having an emission luminance which varies according to a current, a light guide plate outputting lights from the first light source and the second light source in a predetermined direction, and a display panel using the lights incoming from the light guide plate to display an image, is allowed to drive the first light source and the second light source and to fix a current of one of the first light source and the second light source and variably control a current of the other one of the first light source and the second light source according to a target value of a chromaticity of a combined light of the lights output from the light guide plate.

As apparent from the above, the invention can make the luminance adjustment range of the display apparatus wider than the one achieved by the related arts.

### BRIEF DESCRIPTION OF THE DRAWINGS

FIG. 1 is a diagram showing an example of the configuration of a liquid crystal display apparatus as a first embodiment of a display apparatus to which the present invention is adapted;

FIG. 2 is a block diagram showing an example of the detailed configuration of an inverter unit in a back light device in FIG. 1;

FIG. 3 is a chromaticity diagram for explaining related-art current ratio variable control;

FIG. 4 is a diagram showing one example of the luminance adjustment range of a display apparatus under the related-art current ratio variable control;

FIG. 5 is a diagram showing one example of a scheme of the related-art current ratio variable control, which is premised on a constant total current;

FIG. 6 is a diagram showing examples of phosphors used in a cold-cathode tube;

FIG. 7 is a diagram showing an example of the emission spectrum of each blue phosphor in FIG. 6;

FIG. 8 is a diagram showing an example of the emission spectrum of each green phosphor in FIG. 6;

FIG. 9 is a diagram showing an example of the emission spectrum of each red phosphor in FIG. 6;

FIG. 10 is a chromaticity diagram for explaining current ratio variable control according to one embodiment of the invention;

FIG. 11 is a diagram showing one example of the luminance adjustment range of a display apparatus under the current ratio variable control according to one embodiment of the invention;

FIG. 12 is a diagram showing one example of a scheme of current ratio variable control according to one embodiment of the invention;

FIG. 13 is a diagram showing another example of the scheme of the current ratio variable control according to the embodiment of the invention;

FIG. 14 is a diagram showing the degrees of changes in the chromaticity of a single lamp and in the chromaticity of the liquid crystal surface;

FIG. 15 is a flowchart illustrating one example of the current instruction control process of a current instructing section 21 in the operation of the aforementioned back light device 1;

FIG. 16 is a cross-sectional view of a back light device which is applicable to the display apparatus according to the first embodiment and whose lamp layout positions are different from those shown in FIG. 1;

FIG. 17 is a cross-sectional view showing an example of the configuration of a back light device which is applicable to the display apparatus according to the first embodiment and is equipped with four lamps;

FIG. 18 is a general chromaticity diagram which is the same as the chromaticity diagrams in FIGS. 3 and 10;

FIG. 19 is a diagram showing, in enlargement, an area 151 enclosed by a rectangle in the chromaticity diagram in FIG. 18;

FIG. 20 is a diagram showing the degrees of changes in the color coordinates of a single LED and in the color coordinates of the liquid crystal surface;

FIG. 21 is a diagram showing one example of the configuration of a display apparatus equipped with a back light device which uses three types of LEDs of red, green and blue as a light source;

FIG. 22 is a diagram showing an example of the emission spectrum of a blue LED which is usable as the light source of a back light device in a liquid crystal display apparatus as a second embodiment of a display apparatus to which the present invention is adapted;

FIG. 23 is a diagram showing an example of the emission spectrum of a yellow LED which is usable as the light source of a back light device in the liquid crystal display apparatus as the second embodiment of the display apparatus to which the present invention is adapted;

FIG. 24 is a diagram showing another example of the emission spectrum of the yellow LED which is usable as the light source of a back light device in the liquid crystal display apparatus as the second embodiment of the display apparatus to which the present invention is adapted;

FIG. 25 is a chromaticity diagram for explaining current.ratio variable control according to one embodiment of the invention when the light source is an LED;

FIG. 26 is a diagram showing an example of the configuration of the liquid crystal display apparatus as the second embodiment of the display apparatus to which the present invention is adapted;

FIG. 27 is a diagram showing an example of the configuration of an LED section of the back light device in the liquid crystal display apparatus in FIG. 26;

FIG. 28 is a diagram showing an example of the configuration of an LED drive section of the back light device in the liquid crystal display apparatus in FIG. 26;

FIG. 29 is a diagram showing an example of the configuration of an LED section of the back light device in the liquid crystal display apparatus in FIG. 26, which is different from the example shown in FIG. 27; and

FIG. 30 is a block diagram showing an example of the configuration of a computer as at least a part of the display apparatus to which the invention is adapted.

### DESCRIPTION OF THE PREFERRED EMBODIMENTS

### 1. First Embodiment of a Lighting Apparatus to which the Invention is Adapted

### [Example of the Configuration of a Back Light Device as the First Embodiment of the Lighting Apparatus]

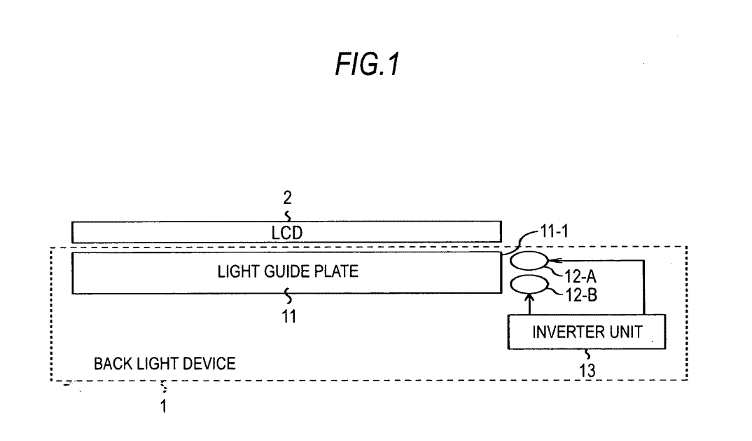

FIG. 1 is a cross-sectional view showing an example of the configuration of a liquid crystal display apparatus used in a notebook type personal computer or the like as a first embodiment of a display apparatus to which the present invention is adapted.

The liquid crystal display apparatus exemplified in FIG. 1 is provided with a back light device 1 and an LCD (Liquid Crystal Display) 2. While LCD generally indicates the whole liquid crystal display apparatus or the like, it particularly indicates a liquid crystal panel herein.

The back light device 1 is provided with a light guide plate 11, two lamps 12-A and 12-B, and an inverter unit 13.

The light guide plate 11 is disposed on the back side of the LCD 2 (the display side of the LCD 2 is the top side) to output lights incoming from the two lamps 12-A and 12-B toward the LCD 2 (in a predetermined direction).

A diffusion sheet, a prism sheet, etc. may be disposed between the top side of the light guide plate 11 (side facing the back side of the LCD 2) and the back side of the LCD 2. In addition, a reflective sheet or the like may be disposed on the back side of the light guide plate 11.

Each of the two lamps 12-A and 12-B is a fluorescent lamp or the like, for example. In the example in FIG. 1, the lamps 12-A, 12-B are disposed at a predetermined face 11-1 (face 11-1 on the right-hand side in FIG. 1) in the four faces of the light guide plate 11 which are perpendicular to the top side thereof, approximately in parallel to the face 11-1 and along the face 11-1.

The inverter unit 13 has two outputs. The first one of the two outputs is connected to the lamp 12-A, while the second output is connected to the lamp 12-B. That is, the inverter unit 13 can individually drive the lamp 12-A and the lamp 12-B.

Specifically, the inverter unit 13 individually applies a high-frequency voltage to the lamp 12-A and the lamp 12-B to cause each of the lamp 12-A and the lamp 12-B to emit light.

At this time, the inverter unit 13 can individually control currents of the lamp 12-A and the lamp 12-B. The current control system is not particularly limited; for example, a PWM (Pulse Width Modulation) control system, an analog current control system, and the like can be employed. The PWM control system controls the average current by switching the ON state and the OFF state of the current from each other and changing the ratio (duty) of the ON state to the OFF state. This PWM control system may be called a duty control system or a pulse width control system. The analog current control system controls the size of a current value analogously.

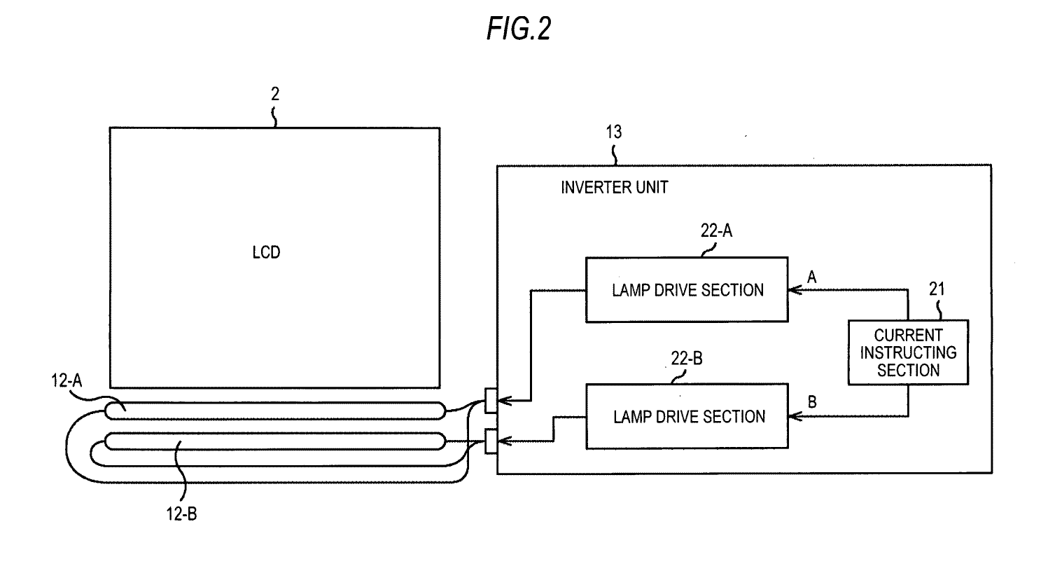

FIG. 2 is a functional block diagram showing an example of the functional configuration of the inverter unit 13.

As shown in FIG. 2, the inverter unit 13 is configured to include a current instructing section 21, and lamp drive sections 22-A and 22-B.

The current instructing section 21 inputs a signal A instructing the level of the current of the lamp 12-A (hereinafter, such a signal is called “individual luminance control signal A”) to the lamp drive section 22-A. The current instructing section 21 also inputs a signal B instructing the level of the current of the lamp 12-B (hereinafter, such a signal is called “individual luminance control signal B”) to the lamp drive section 22-B.

The lamp drive section 22-A drives the lamp 12-A to control the current of the lamp 12-A based on the individual luminance control signal A from the current instructing section 21. The lamp drive section 22-B drives the lamp 12-B to control the current of the lamp 12-B based on the individual luminance control signal B from the current instructing section 21.

### [Brief Description of the Back Light Device Described in Patent Document 5]

To help understanding the present invention, the back light device described in Patent Document 5, which has been explained in the foregoing “DESCRIPTION OF THE RELATED ART” will be briefly described.

The configuration of the back light device described in Patent Document 5 (hereinafter called “related-art back light device”) can take the configuration shown in FIGS. 1 and 2. The outline of the related-art back light device will be explained below using reference numerals given in FIGS. 1 and 2.

The related-art back light device executes control to keep the actual level of the sum of the currents (hereinafter called “total current”) of a plurality of lamps (lamp 12-A and lamp 12-B in the example in FIG. 1) at a target level (level corresponding to the target luminance). To keep the color coordinates of the actual chromaticity of light output from the light guide plate 11 at a target value, the related-art back light device executes control to change the distribution ratio of the total current (hereinafter called “current ratio”) for each of a plurality of lamps. This control is hereinafter called “current ratio variable control”.

From the viewpoint of changing the color coordinates of a chromaticity, it is not particularly necessary to control the total current, but it is simply sufficient to execute the current ratio variable control. The current ratio variable control includes the control of increasing or decreasing the current of one type of lamp while making the currents of the other types of lamps constant. In this respect, the back light device to which the invention is adapted executes the current ratio variable control independently of the total current.

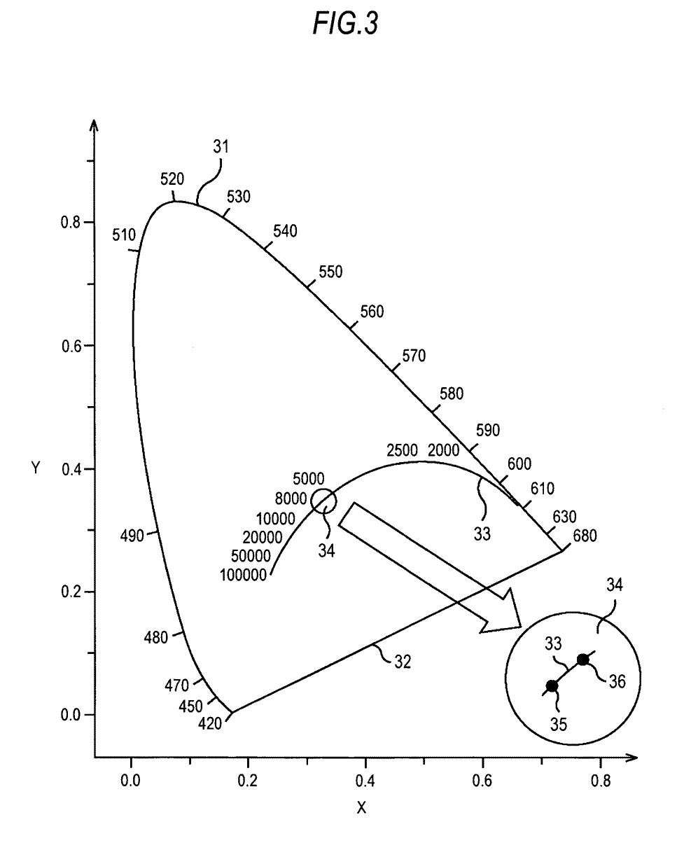

The current ratio variable control applied to the related-art back light device (hereinafter called “related-art current ratio variable control”) differs from the current ratio variable control applied to the back light device to which the invention is adapted (hereinafter called “current ratio variable control of the invention”). For ease of understanding the current ratio variable control of the invention, therefore, the related-art current ratio variable control will be described referring to a chromaticity diagram in FIG. 3 before explaining the current ratio variable control of the invention.

FIG. 3 is a chromaticity diagram for explaining the related-art current ratio variable control.

In the chromaticity diagram in FIG. 3, a curve 31 indicates a spectrum color locus. That is, individual monochromatic lights of spectra having pure colors are located on the spectrum color locus 31. Individual numerals given near the spectrum color locus 31 respectively indicate the wavelengths of the individual monochromatic lights. A straight line 32 indicates a purple boundary 32. That is, pure light of magenta which is not in the light spectrum and is obtained by blending monochromatic lights of purple and red is located on the purple boundary 32. Therefore, every the color can be expressed as a point in the range enclosed by the spectrum color locus 31 and the purple boundary 32, or a point with coordinates (x, y) in the chromaticity diagram. This point is called chromaticity, and the coordinates (x, y) that specify the position of a chromaticity are called chromaticity coordinates (x, y).

A curve 33 indicates a black body curve. The black body curve is the locus of the chromaticity of light which is output from a black body (ideal object which completely absorbs a light of every wavelength) when the black body is burned. The individual numerals given near the black body curve 33 respectively indicate the temperatures of black bodies emitting the chromaticities (points) indicated by the numerals. This temperature is called color temperature, which indicates a chromaticity (point) on the black body curve 33. That is, a chromaticity (point) on the black body curve 33 can be expressed by the chromaticity coordinates as well as the color temperature.

Let us consider a case where a first light of a first chromaticity and a second light of a second chromaticity are spatially blended in the chromaticity diagram. In this case, a third chromaticity (point) of a third light obtained by blending the first light and the second light is positioned on a straight line connected by the first chromaticity (point) and the second chromaticity (point). Note that where on the line the third chromaticity (point) is positioned depends on a first light quantity (luminance) of the first light and a second light quantity (luminance) of the second light. Therefore, the position of the third chromaticity (point), i.e., the chromaticity coordinates thereof, can be adjusted by changing the ratio of the first light quantity (luminance) of the first light to the second light quantity (luminance) of the second light.

In this respect, a lamp made to emit the first chromaticity with the first chromaticity is adopted as the lamp 12-A. In addition, a lamp made to emit the second chromaticity with the second chromaticity is adopted as the lamp 12-B. Accordingly, the chromaticity coordinates of the third chromaticity of the third light output from the light guide plate 11 or the third light output from the LCD 2 can be adjusted by changing the ratio of the light quantities (luminances) of the lamps 12-A and 12-B.

Patent Document 5 describes that it is desirable to employ the scheme of setting the first chromaticity of the lamp 12-A and the second chromaticity of the lamp 12-B on the black body curve 33 within a predetermined range 34 as shown in FIG. 3. That is, Patent Document 5 describes that it is desirable to employ the scheme of setting one of the chromaticity 35 and the chromaticity 36 as the first chromaticity and setting the other one as the second chromaticity. Patent Document 5 gives the reason such that the target chromaticity of the liquid crystal display apparatus is often set by the color temperature (i.e., chromaticity on the black body curve 33). In short, such a setting scheme is taken because it is efficient to use the color temperature 35 (chromaticity 35 on the black body curve 33) and the color temperature 36 (chromaticity 36 on the black body curve 33) in case of adjusting the chromaticity of light to be output from the top surface of the light guide plate 11 with the color temperature.

As shown in FIG. 3, the color coordinates of the color temperature 35 and the color temperature 36 are in the vicinity of 6500K. The lamps 12-A and 12-B used in the related-art back light device need to be made to emit lights with the chromaticities of the color coordinates near 6500K. Accordingly, the lamps 12-A and 12-B used in the related-art back light device need to be formed by using three types of phosphors of red, green and blue.

In a case where the lamps 12-A and 12-B are made by three types of phosphors of red, green and blue and the x/y values of the lamps 12-A and 12-B are relatively close to each other, however, the current ratio of the lamps 12-A and 12-B should be large in order to make the color coordinates variable. For example, it is assumed that the third chromaticity (color temperature) of the third light output from the light guide plate 11 (i.e., third light output from the LCD 2) is set to 6500K. It is also assumed that the lamp 12-A with the color temperature of 6500K and the lamp 12-B with the color temperature of 9300K are made. In this case, the current ratio of the lamps 12-A and 12-B becomes 1:0. That is, the current of the lamp 12-A becomes 100%, while the current of the lamp 12-B becomes 0%.

It is to be noted however that the current restrictions of the lamps 12-A and 12-B are given on both the maximum current side and the minimum current side. In consideration of the stability of the lamps 12-A, 12-B, the minimum current is limited to about 20% of the maximum current. Therefore, the maximum luminance of the display apparatus is restricted by the maximum currents of the lamps 12-A, 12-B, and the minimum luminance of the display apparatus is restricted by the minimum currents of the lamps 12-A, 12-B.

Because the related-art current ratio variable control needs to set the current ratio of the lamps 12-A and 12-B large, adjustment of the luminance with the current ratio set constant or with the chromaticities set identical brings about the following demerits. That is, the variable range of the total current of the lamps 12-A and 12-B becomes narrower, and the variable range of the maximum luminance total current and minimum luminance of the display apparatus (luminance adjustment range) becomes narrower.

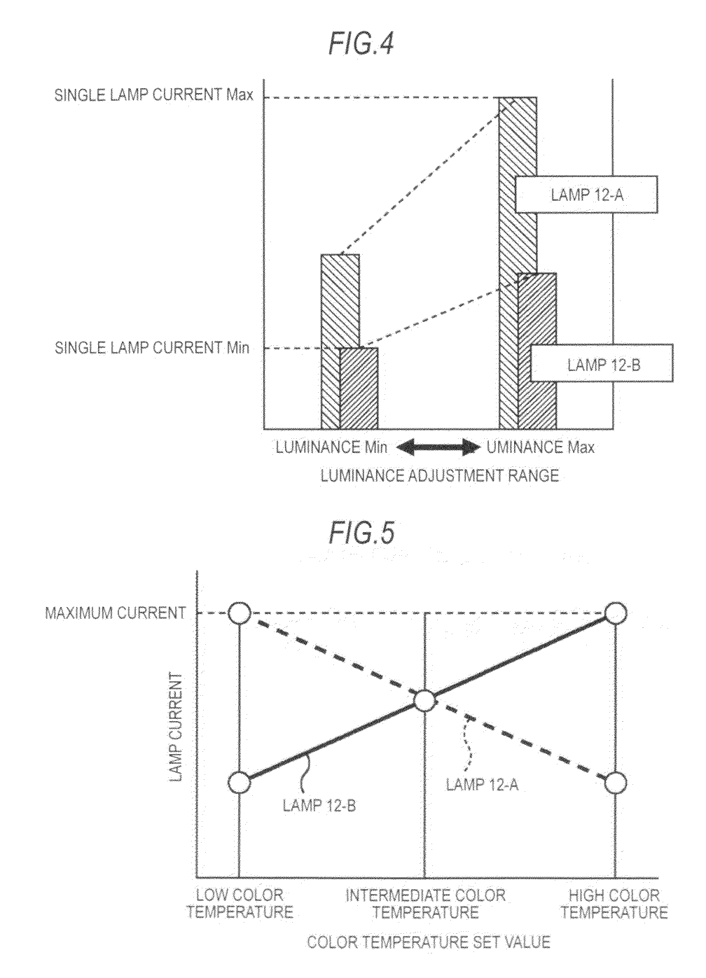

FIG. 4 shows one example of the luminance adjustment range of the display apparatus under the related-art current ratio variable control.

In the example shown in FIG. 4, the current ratio of the lamps 12-A and 12-B is fixed to 2:1. In this case, as shown in FIG. 4, the minimum luminance of the display apparatus is restricted by the minimum current of the lamp 12-B while the maximum luminance of the display apparatus is restricted by the maximum current of the lamp 12-A. It is apparent, though not illustrated, that those restrictions make the variable range (luminance adjustment range) of the maximum luminance and the minimum luminance of the display apparatus narrower as the current ratio becomes larger.

As mentioned above, the related-art current ratio variable control is premised on that the total current of the lamps 12-A and 12-B is set constant.

FIG. 5 shows one example of a scheme of the related-art current ratio variable control, which is premised on a constant total current.

In the example in FIG. 5, color temperatures can be set by three types of variable setting for a low color temperature (e.g., 5000K), an intermediate color temperature (e.g., 6500K), and a high color temperature (e.g., 9300K).

In this case, it is apparent from FIG. 5 that any of the three types of color temperature setting prevents the maximum current from flowing in the lamps 12-A and 12-B from simultaneously. That is, the related-art current ratio variable control does not effectively use the current allowance range of the lamps, bringing about the demerit such that the original luminance output performance of the lamps cannot be demonstrated fully, thus resulting in reduction in the luminance of the display apparatus.

[Current Ratio Variable Control to which the Invention is Adapted]

In view of the above, the present inventor has conceived the scheme of the following current ratio variable control (hereinafter “current ratio variable control of the invention”).

The current ratio variable control of the invention employs a first light source which is made by a blue phosphor and whose emission luminance varies according to the current, and a second light source which is made in such a way that a line connecting the chromaticity of the first light source to the chromaticity of the second light source passes a part of the black body curve and whose emission luminance varies according to the current. In other words, the types of the first and second light sources are not limited as long as the first and second light sources fulfill the above conditions.

The following description will be given of a case where one of the lamps 12-A and 12-B is used as each of the first light source and the second light source by way of example. Specifically, one of the lamps 12-A and 12-B is formed by two phosphors, namely a red phosphor and a green phosphor. Such a lamp is hereinafter called “RG lamp”. The other lamp is formed by a blue phosphor. Such a lamp is hereinafter called “B lamp”.

A lamp formed by a phosphor of a predetermined color does not imply a narrow concept that such a lamp includes only a lamp formed 100% by a phosphor of a predetermined color, but a broad concept that the lamp includes a lamp formed substantially, if not 100%, by a phosphor of a predetermined color. That is, the B lamp need not contain 100% of a blue phosphor, but may slightly contain a red phosphor or green phosphor. Likewise, the RG lamp may slightly contain a blue phosphor.

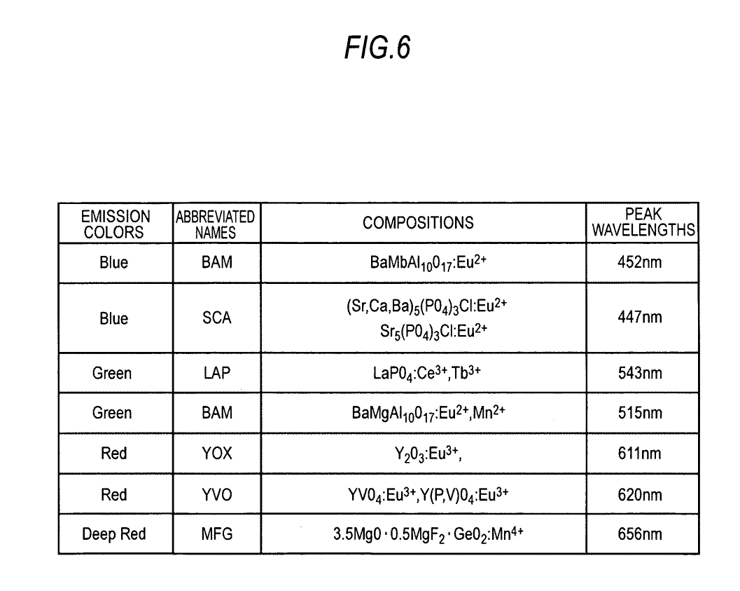

FIG. 6 shows examples of phosphors used in a cold-cathode tube in a table. The table in FIG. 6 shows “emission colors”, “abbreviated names”, “compositions” and “peak wavelengths” provided in order from the left as items indicating the properties of the phosphors. That is, a substance having each property described in each row of each item indicates a predetermined single phosphor.

The blue phosphor is a substance which gets energy from outside and converts the energy to a blue light. Specifically, in the example in FIG. 6, phosphors having “Blue” described in the item “emission colors”, i.e., phosphors having the properties described in the first and second rows in FIG. 6 from the top, can be employed as a blue phosphor.

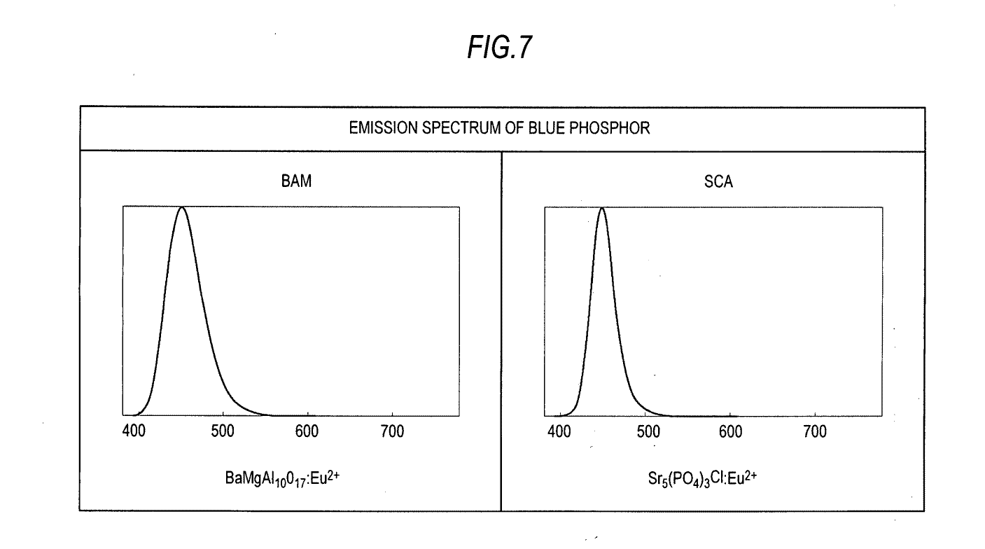

FIG. 7 shows an example of the emission spectrum of each blue phosphor in FIG. 6.

The green phosphor is a substance which gets energy from outside and converts the energy to a green light. Specifically, in the example in FIG. 6, phosphors having “Green” described in the item “emission colors”, i.e., phosphors having the properties described in the third and fourth rows in FIG. 6 from the top, can be employed as a green phosphor.

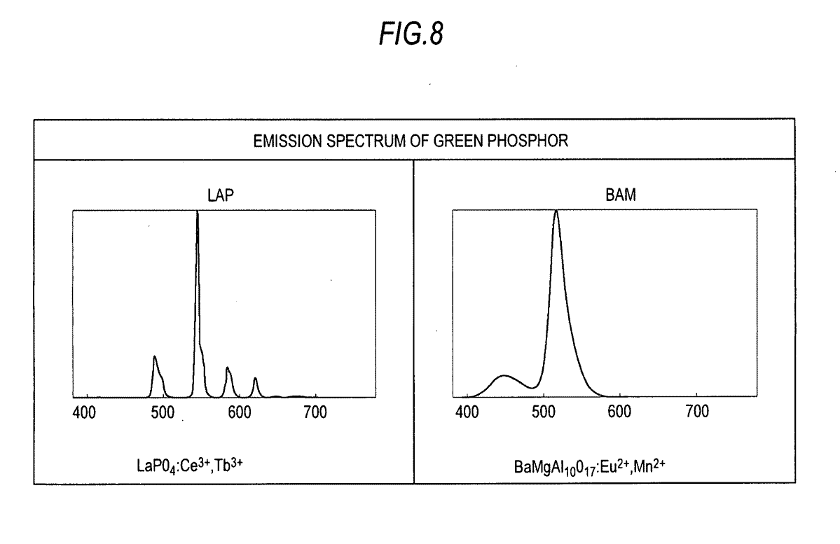

FIG. 8 shows an example of the emission spectrum of each green phosphor in FIG. 6.

The red phosphor is a substance which gets energy from outside and converts the energy to a red light. Specifically, in the example in FIG. 6, phosphors having “Red” described in the item “emission colors”, i.e., phosphors having the properties described in the fifth to seventh rows in FIG. 6 from the top, can be employed as a red phosphor.

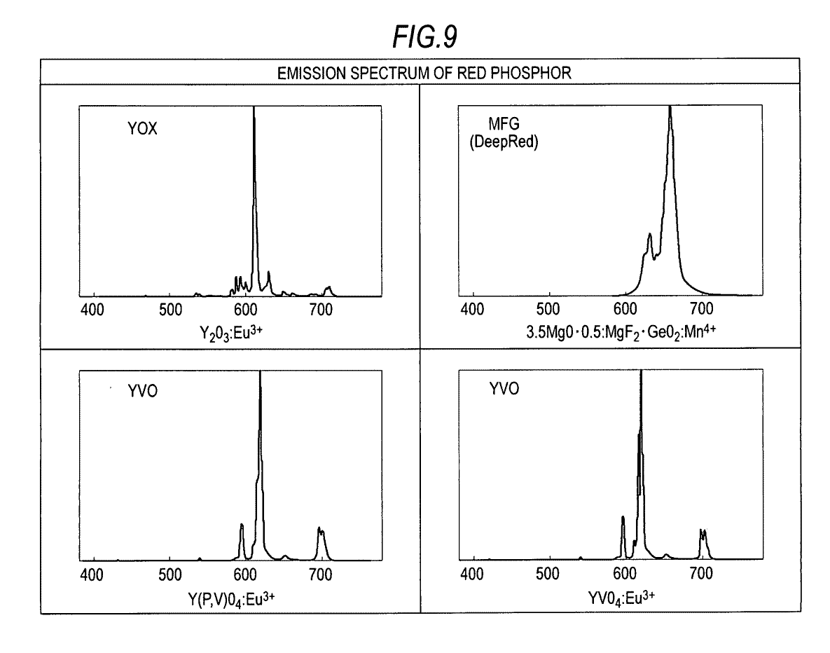

FIG. 9 shows an example of the emission spectrum of each red phosphor in FIG. 6.

In short, the related-art current ratio variable control employs a set of two lamps each of which is formed by a red phosphor, a green phosphor and a blue phosphor as a set of the lamps 12-A and 12-B. The current ratio variable control of the invention employs an RG lamp made by a red phosphor and a green phosphor, and a B lamp made by a blue phosphor. This can set the difference between the color coordinates of the set of the lamps 12-A and 12-B larger than the one provided in the related art. The following will discuss this point more specifically.

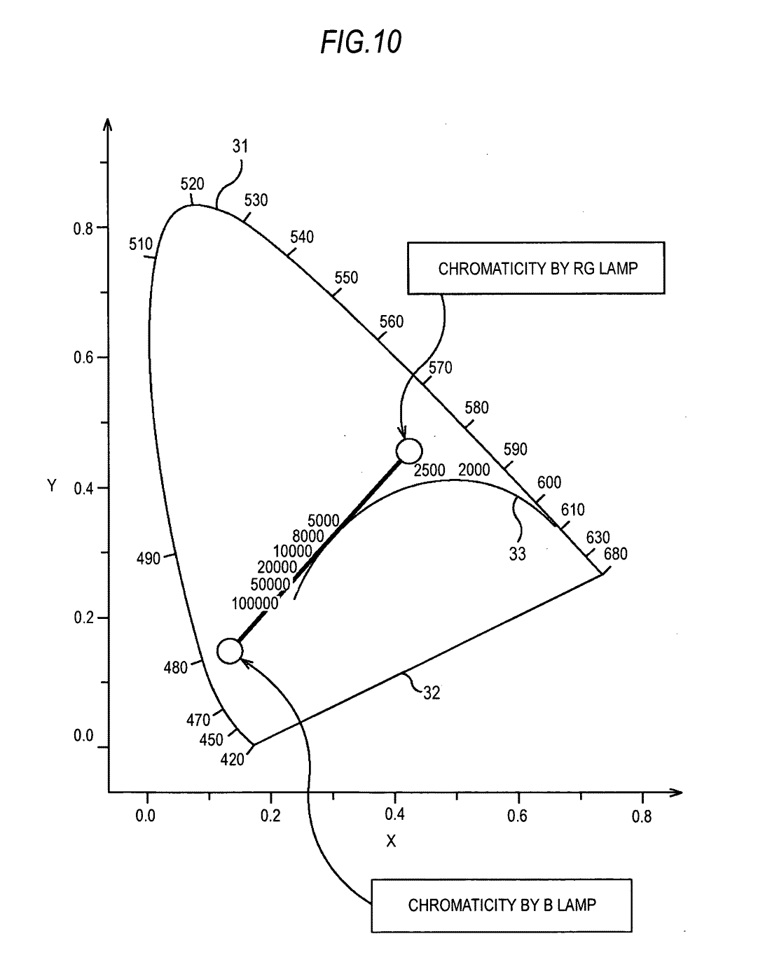

FIG. 10 is a chromaticity diagram for explaining the current ratio variable control of the invention.

The chromaticity diagram in FIG. 10 is the same as the chromaticity diagram in FIG. 3 for explaining the related-art current ratio variable control.

It is apparent that the chromaticity provided by the RG lamp shown in FIG. 10, for example, is a chromaticity of more yellowish color coordinates (x/y value is at coordinates in the upper rightward direction) as compared with the chromaticity 36 provided by the related-art lamp shown in FIG. 3. It is also apparent that the chromaticity provided by the B lamp is a chromaticity of more bluish color coordinates (x/y value is at coordinates in the lower leftward direction) as compared with the chromaticity 35 provided by the related-art lamp shown in FIG. 3. Therefore, using the set of the RG lamp and B lamp as the set of the lamps 12-A and 12-B makes it possible to set the difference between the color coordinates of the lamps 12-A and 12-B larger than the one provided in the related art.

In this case, according to the current ratio variable control of the invention, changing the current ratio of the RG lamp and B lamp can allow the color coordinates matching with the current ratio to be set within the range of the line connecting their chromaticities.

In the example in FIG. 10, for example, the line connecting the chromaticities of the RG lamp and the B lamp is substantially in parallel to the black body curve 33 near the color temperature of 6500K. For example, this line passes an area near 5000K (area with x=0.348±0.01, y=0.352±0.01) and an area near 6500K (area with x=0.311±0.01, y=0.323±0.01). Note that the near-5000K area means the chromaticity of a standard illumination light B (x/y=0.3484/0.3516). The near-6500K area means an average value of the chromaticity of a standard illumination light D65 (x/y=0.3127/0.3290) and

the chromaticity of a standard illumination light C (x/y=0.3101/0.3162).

Therefore, for example, two points, 6500K and 5000K, can be set as the chromaticities of a light output from the light guide plate 11 or the chromaticity coordinates of the chromaticity of a light output from the LCD 2. For example, let us consider the case of setting 6500K for comparison with what is shown in FIG. 3. In this case, according to the current ratio variable control of the invention, the inverse ratio of the linear distance between the chromaticity of the RG lamp and 6500K and the linear distance between the chromaticity of the B lamp and 6500K can be set as the current ratio of the RG lamp and B lamp in the chromaticity diagram in FIG. 10. According to the related-art current ratio variable control, by way of comparison, the inverse ratio of the linear distance between the chromaticity 35 and 6500K and the linear distance between the chromaticity 36 and 6500K can be set as the current ratio of the two lamps in the chromaticity diagram in FIG. 3. In this case, the linear distance between the chromaticity of the RG lamp and 6500K and the linear distance between the chromaticity of the B lamp and 6500K (see the chromaticity diagram in FIG. 10) become comparatively longer than the linear distance between the chromaticity 35 and 6500K and the linear distance between the chromaticity 36 and 6500K in the related art (see the chromaticity diagram in FIG. 3). Therefore, the current ratio which is settable under the current ratio variable control of the invention can be made relatively smaller than the current ratio which is settable under the related-art current ratio variable control.

The maximum currents are determined for the B lamp and the RG lamp as per the related-art lamps. According to the current ratio variable control of the invention, however, the target (purpose of setting 6500K in the above-described example) can be achieved even when the current ratio is small. This means that the variable range of the total current of the two types of lamps, the B lamp and the RG lamp, can be set wider than that of the related art, which further means that the general luminance of the display apparatus can be set large. It also means that the minimum current can be set smaller, thus making it possible to set the luminance narrower.

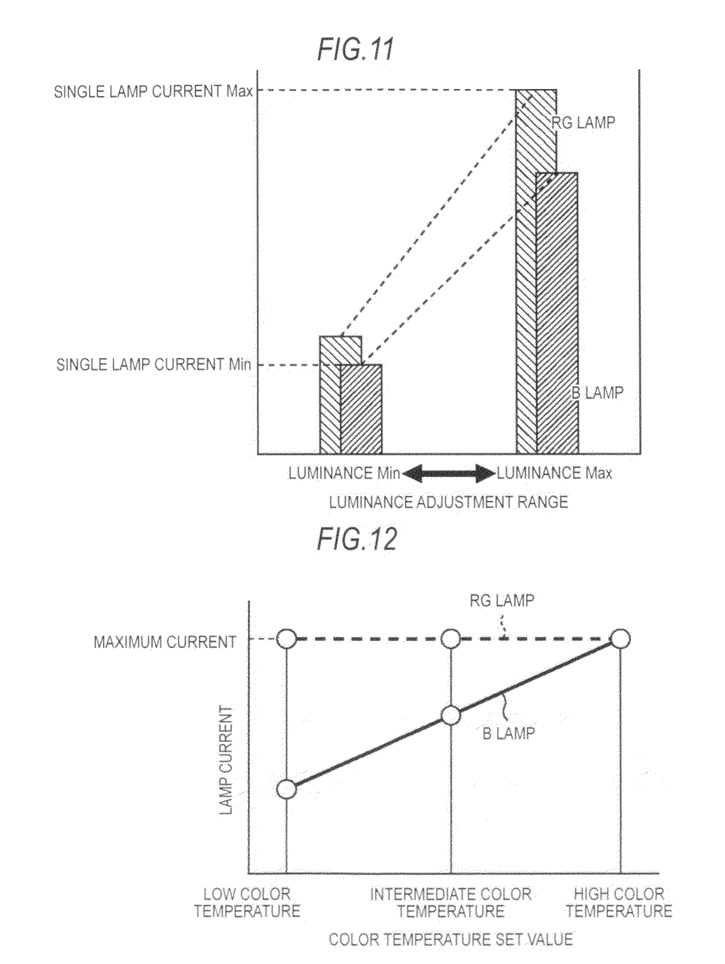

FIG. 11 shows one example of the luminance adjustment range of the display apparatus under the current ratio variable control of the invention.

In the example shown in FIG. 11, the current ratio of the RG lamp and the B lamp (current ratio of the lamps 12-A and 12-B) is fixed to a ratio smaller than the current ratio of 2:1 in the related art of FIG. 4. In this case, the minimum luminance of the display apparatus is restricted by the minimum current of the B lamp while the maximum luminance of the display apparatus is restricted by the maximum current of the RG lamp, as in the related art. Because the current ratio of the RG lamp and the B lamp is lower than the current ratio in the related art (current ratio in the example shown in FIG. 4), however, the variable range (luminance adjustment range) of the maximum luminance and the minimum luminance of the display apparatus can be set wider accordingly.

Further, the assumption in the related-art current ratio variable control or the assumption that the total current of the lamps 12-A and 12-B (total current of the RG lamp and the B lamp according to the embodiment of the invention) is set constant is not particularly required as the assumption under the current ratio variable control of the invention.

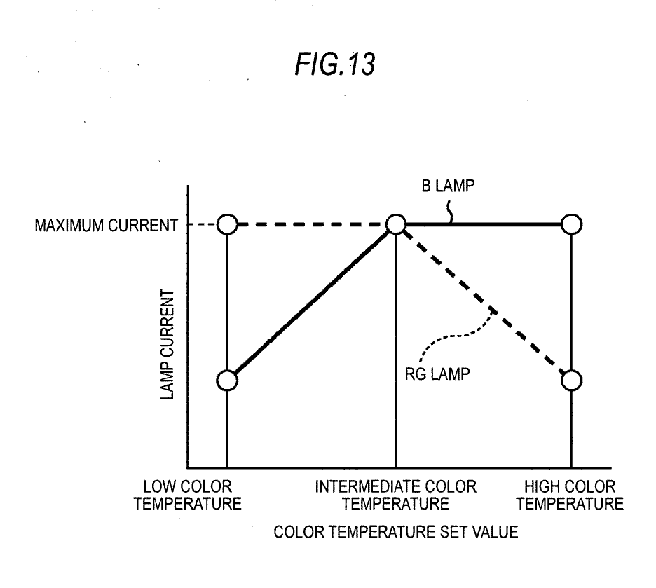

It is therefore possible to achieve the current ratio variable control as shown in FIG. 12 or FIG. 13, for example.

FIGS. 12 and 13 show two examples of the scheme of the current ratio variable control of the invention, respectively.

In the examples in FIGS. 12 and 13, to make comparison with the related art easier, color temperatures can be set by three types of variable setting for a low color temperature (e.g., 5000K), an intermediate color temperature (e.g., 6500K), and a high color temperature (e.g., 9300K) as per the related-art example in FIG. 5.

In the example in FIG. 12, the current is controlled in such a way as to set the current of the B lamp according to the set value of the chromaticity while the current of the RG lamp is fixed to the maximum current, i.e. without controlling the current of the RG lamp. That is, the current of the B lamp is controlled in such a way that the current ratio of the RG lamp and the B lamp becomes 1:K (K is a value equal to or less than 1 and different from the set value of each chromaticity).

In the related-art current ratio variable control exemplified in FIG. 5, the current ratio for changing the chromaticity is adjusted with the total current of the lamps 12-A and 12-B being set substantially constant, requiring current control on both of the lamps 12-A and 12-B. By way of contrast, the use of the current ratio variable control of the invention makes it sufficient to execute current control on only the B lamp in the lamps 12-A and 12-B without executing current control on the RG lamp as adjustment of the current ratio for changing the chromaticity. With current control on the B lamp alone being sufficient, the current ratio variable control of the invention can be made simpler than the related-art current ratio variable control.

Further the B lamp mainly emits a blue light. Blue has the least influence on luminance among the three primary colors of red, green and blue. According to the NTSC (National Television Standards Committee) standards, for example, the contribution ratios of red, green and blue on the individual luminances are defined as about 30% for red and about 63% for green, in comparison with about 7% for blue. Therefore, even when the chromaticity of the display apparatus is changed only by the current control of the B lamp, the change in the luminance of the display apparatus can be kept small.

In case of employing the current ratio variable control exemplified in FIG. 12, the chromaticities of the RG lamp and the B lamp have only to be decided in such a way that the chromaticity of the display apparatus becomes the target high color temperature (e.g., 9300K) when the maximum currents (or the same current) are let to flow in the RG lamp and the B lamp. When the B lamp is made by a blue phosphor alone, for example, the chromaticity of the B lamp is decided. Accordingly, adjustment of the chromaticity by dispensing the phosphors of the RG lamp allows the target high color temperature (e.g., 9300K) to be achieved when the same current is let to flow in the RG lamp and the B lamp.

Comparing the related-art current ratio variable control exemplified in FIG. 5 with the current control of the invention exemplified in FIG. 12, as mentioned above, the maximum currents cannot be let to flow in the two lamps 12-A and 12-B simultaneously in the example in FIG. 5, whereas in the current ratio variable control of the invention exemplified in FIG. 12, with the high color temperature (e.g., 9300K) being set, the maximum currents can be let to flow in both of the RG lamp and B lamp (lamps 12-A and 12-B). As a result, the maximum luminance of the display apparatus can be set large as compared with the related art. With the intermediate color temperature (e.g., 6300K) being set, the maximum current (or current larger than at least the current of the lamp 12-A in FIG. 5) can be let to flow in the RG lamp. Further, because the RG lamp mainly emits red and green lights, the degree of contribution on the luminance of the display apparatus is large as mentioned above. Therefore, the luminance of the display apparatus becomes larger than that of the related art.

The example shown in FIG. 13 which is different from one example of the current ratio variable control of the invention shown in FIG. 12 is configured to permit the maximum currents to flow in the RG lamp and the B lamp (lamps 12-A and 12-B) with the intermediate color temperature (e.g., 6300K). It is favorable to adapt the example in FIG. 13 to a display apparatus which is used as a monitor for a personal computer, for example. This is because the color temperature most frequently used for still pictures of a personal computer is 6500K.

The example in FIG. 13 needs current control on both of the B lamp and the RG lamp, not current control on the B lamp alone as done in the example in FIG. 12.

In case of employing the current ratio variable control exemplified in FIG. 13, the chromaticities of the RG lamp and the B lamp have only to be decided in such a way that the chromaticity of the display apparatus becomes the target intermediate color temperature (e.g., 6500K) when the maximum currents (or the same current) are let to flow in the RG lamp and the B lamp. When the B lamp is made by a blue phosphor alone, for example, the chromaticity of the B lamp is decided. Accordingly, adjustment of the chromaticity by dispensing the phosphors of the RG lamp allows the target intermediate color temperature (e.g., 6500K) to be achieved when the same current is let to flow in the RG lamp and the B lamp.

The configuration of the back light device 1 shown in FIGS. 1 and 2 has been described, followed by the description of the scheme of the current ratio variable control of the invention which has been compared with the related-art current ratio variable control as needed. Next, the operation of the back light device 1 shown in FIGS. 1 and 2 will be described.

### [Operational Example of the Back Light Device as the First Embodiment of the Lighting Apparatus]

The control section or the like (not shown) generates a chromaticity instruction based on the target chromaticity (target values of color coordinates) of the light from the light guide plate 11. That is, the control section or the like generates a signal with a voltage level corresponding to the target chromaticity as a chromaticity instruction. Then, the control section or the like supplies the chromaticity instruction to the current instructing section 21.

For example, it is assumed in the embodiment that the following signal is used as a chromaticity instruction. As mentioned above, the chromaticity of the light from the light guide plate 11 the chromaticity of the light from the LCD2 can be adjusted by changing the current ratio of the B lamp and the RG lamp (lamps 12-A and 12-B). Therefore, it is assumed that a signal needed to set the current ratio of the RG lamp and the B lamp in the reference state (hereinafter called “base current ratio”) is used as the chromaticity instruction.

Specifically, a chromaticity instruction is a voltage signal in the range of 0 [V] to 3 [V]. When the current ratio variable control of the invention exemplified in FIG. 12 is used, a voltage signal with a maximum value (i.e., 3.0 V) in the range indicates an instruction to set the currents of the B lamp and the RG lamp equal to each other (instruction to set the current ratio to 1:1). A voltage signal in the range of 0 [V] to less than 3 [V] indicates an instruction to let the maximum current to flow in the RG lamp and let the current smaller than the maximum current and having a size according to the instructed target value to flow in the B lamp. In other words, when the current ratio variable control of the invention exemplified in FIG. 12 is used, a constant current (maximum current) flows in the RG lamp, so that the chromaticity instruction simply becomes a current instruction for the B lamp.

When the current ratio variable control of the invention exemplified in FIG. 13 is used, by way of contrast, a voltage signal which is the center of the range (i.e., 1.5 V) indicates an instruction to set the currents of the B lamp and the RG lamp equal to each other (instruction to set the current ratio to 1:1). A voltage signal in the range of 0 [V] to less than 1.5 [V] indicates an instruction to let the maximum current to flow in the RG lamp and let the current smaller than the maximum current and having a size according to the instructed target value to flow in the B lamp. As the voltage value increases in the range of 0 [V] to less than 1.5 [V], the current of the B lamp becomes larger. Meanwhile, a voltage signal in the range of 1.5 [V] to 3 [V] (excluding 1.5 [V]) indicates an instruction to let the maximum current to flow in the B lamp and let the current smaller than the maximum current and having a size according to the instructed target value to flow in the RG lamp. As the voltage value increases in the range of 1.5 [V] to 3 [V], the current of the RG lamp becomes smaller.

In accordance with such a chromaticity instruction, the current instructing section 21 sets the current ratio of the RG lamp and the B lamp and generates the individual luminance control signal A and the individual luminance control signal B. Specifically, when the current ratio of the RG lamp and the B lamp is set to p:q (p and q are arbitrary integers), for example, the current instructing section 21 generates the individual luminance control signal A and the individual luminance control signal B whose voltage level ratio becomes substantially p:q. When the current ratio variable control of the invention exemplified in FIG. 12 is employed, p becomes a fixed value equal to 1, and q becomes a variable equal to or less than 1.

The individual luminance control signal A generated in this manner is supplied to the lamp drive section 22-A. Meanwhile, the individual luminance control signal B generated in this manner is supplied to the lamp drive section 22-B.

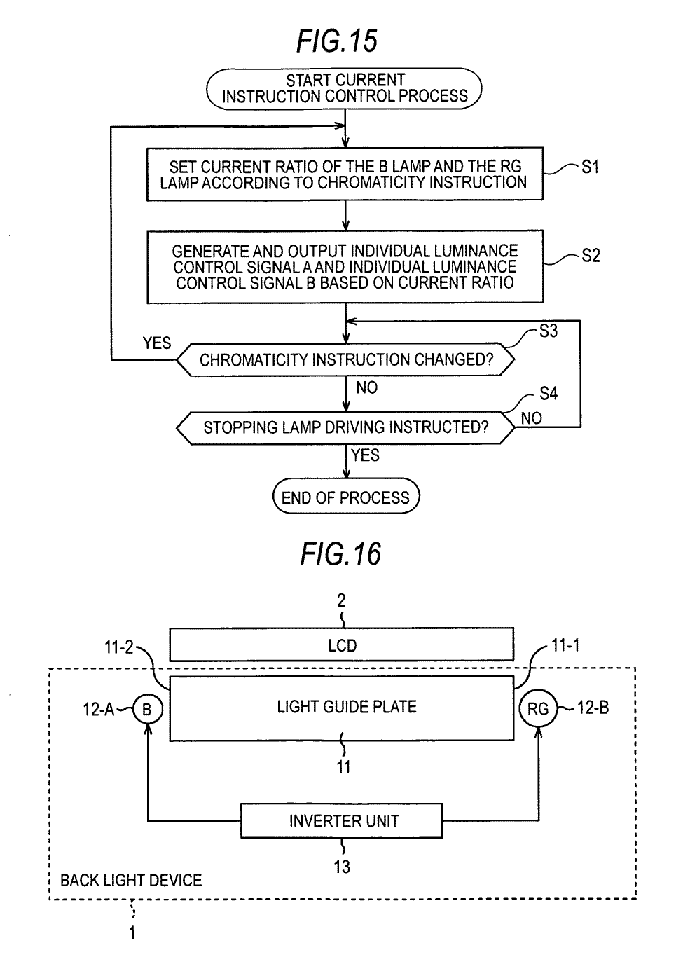

The process of the current instructing section 21 is hereinafter called “current instruction control process”. The details of the current instruction control process will be given later referring to a flowchart illustrated in FIG. 15.

The lamp drive section 22-A drives the lamp 12-A and controls the current (level) of the lamp 12-A based on the supplied individual luminance control signal A. Likewise, the lamp drive section 22-B drives the lamp 12-B and controls the current (level) of the lamp 12-B based on the supplied individual luminance control signal B.

For the sake of descriptive simplicity, it is assumed below that the B lamp is used as the lamp 12-A and the RG lamp is used as the lamp 12-B. It is of course needless to say that the reverse selection is also feasible.

As a result of the independent current control on the lamp drive section 22-A and the lamp drive section 22-B, the actual current ratio of the B lamp and the RG lamp (lamps 12-A and 12-B) substantially matches with the current ratio (set value) set by the current instructing section 21. That is, the each of the B lamp and the RG lamp emits light of a predetermined chromaticity with the luminance (light quantity) corresponding to the respective controlled current level.

A light obtained by spatially blending the light from the B lamp and the light from the RG lamp is output from the top surface of the light guide plate 11 (i.e., the top surface of the LCD 2). As a result, the actual chromaticity of the light output from the top surface of the light guide plate 11 is kept substantially constant at the target value.

Because the current ratio variable control of the invention need not make the total current identical in the luminance adjustment of the liquid crystal display apparatus, the individual luminance control signal A and the individual luminance control signal B may be multiplied by the gain of the same magnification which corresponds to the luminance instruction.

In the foregoing description of the examples, for the sake of descriptive simplicity, the chromaticity (color temperature or the like) basically has been explained using color coordinates at the top surface of the display apparatus such as a liquid crystal display apparatus. However, it is to be noted that the chromaticity of each of the B lamp and the RG lamp or the chromaticity of the back light device 1 is not identical to the chromaticity of the last liquid crystal surface.

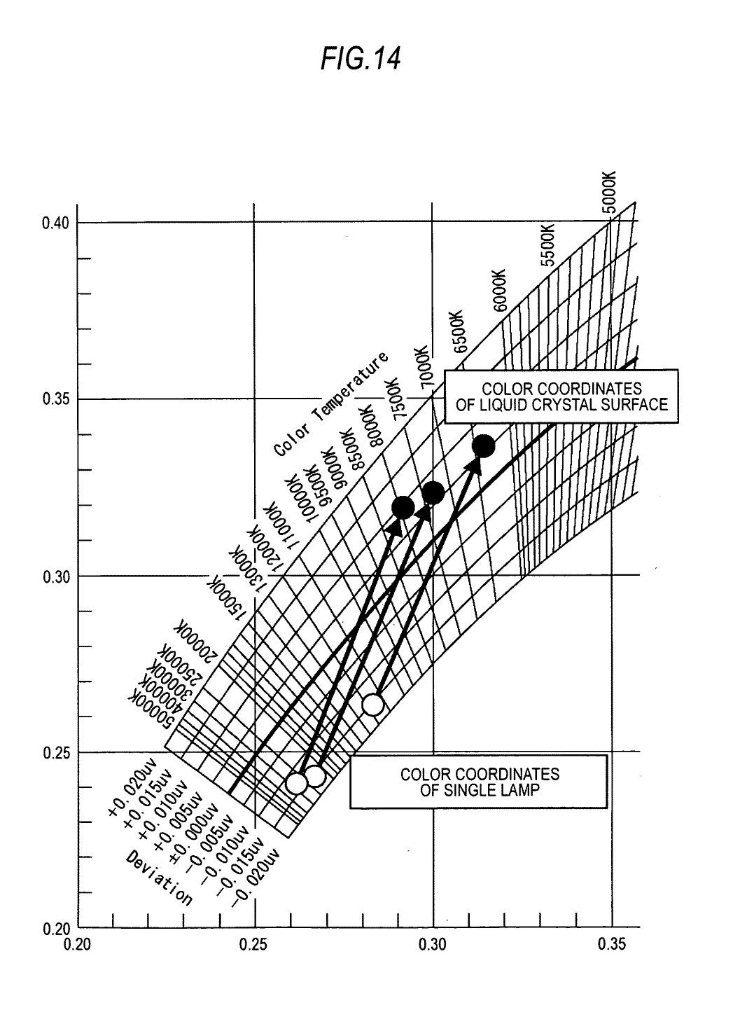

FIG. 14 is a diagram showing the degrees of changes in the chromaticity of a single lamp and in the chromaticity of the liquid crystal surface.

As shown in FIG. 14, the chromaticity shifts from the chromaticity of a single lamp to the chromaticity at the last liquid crystal surface. That is, as the light from a single lamp travels through the back light device 1 including the light guide plate 11 and various sheets, and further travels through the color filters, polarizing plates and liquid crystal, the light is finally input to human eyes as a light (image) from the display apparatus. Accordingly, the chromaticity of a single lamp differs from the chromaticity on the display apparatus. Actually, therefore, it is necessary to perform various settings in the current ratio variable control of the invention and make the B lamp and the RG lamp in consideration of the shift of the chromaticity.

FIG. 15 is a flowchart illustrating one example of the current instruction control process of the current instructing section 21 in the operation of the aforementioned back light device 1.

For the sake of descriptive simplicity, it is assumed that the luminance instruction is a fixed value. It is to be noted however that designing a variable luminance instruction facilitates the luminance adjustment as mentioned above.

In step S1, the current instructing section 21 sets the current ratio of the B lamp and the RG lamp according to the chromaticity instruction. When the current ratio variable control of the invention exemplified in FIG. 12 is employed, a constant current (maximum current) flows in the RG lamp, so that setting of the current ratio of the B lamp and the RG lamp substantially means setting of the current value of the B lamp.

In step S2, the current instructing section 21 generates and outputs the individual luminance control signal A and the individual luminance control signal B based on the current ratio set in the process of step S1.

In step S3, the current instructing section 21 determines whether the chromaticity instruction has changed or not.

When it is determined in step S3 that the chromaticity instruction has not changed, the process goes to step S4. In step S4, the current instructing section 21 determines whether stopping the lamp driving is instructed or not. While the instruction to stop the lamp driving is not particularly limited, stopping the issuance of the luminance instruction is used as the instruction to stop the lamp driving in the embodiment. As long as the luminance instruction is issued, i.e., as long as a predetermined voltage value is supplied to the current instructing section 21 as the luminance instruction, the decision in step S4 is NO, and the process returns to step S3 to determine again whether the chromaticity instruction has changed or not.

When the chromaticity instruction has changed, the decision in step S3 is YES, and the process returns to step S1 to repeat the sequence of processes starting thereat. That is, the setting of the current ratio is updated, and the individual luminance control signal A and the individual luminance control signal B are generated and output based on the updated current ratio.

When the issuance of the luminance instruction is stopped thereafter, i.e., when the voltage value as the luminance instruction becomes 0 [V], the decision in step S4 is YES, and the current instruction control process is terminated.

### [Another Configuration Example of the Back Light Device as the First Embodiment of the Lighting Apparatus]

The layout positions of the B lamp (lamp 12-A) and the RG lamp (lamp 12-B) of the back light device 1 are not limited to those shown in FIGS. 1 and 2, but may be set anywhere the light obtained by spatially blending the light from the B lamp and the light from the RG lamp is output from the light guide plate 11 toward the LCD 2 in a predetermined direction.

FIG. 16 is a cross-sectional view showing another configurational example of a liquid crystal display apparatus used in a notebook type personal computer or the like as an embodiment of the display apparatus to which the invention is adapted, which is different from the example shown in FIG. 1.

As shown in FIG. 16, the lamp 12-A (B lamp) may be disposed at a face 11-2 in the four faces perpendicular to the top surface of the light guide plate 11, substantially in parallel to the face 11-2 and therealong. In addition, the lamp 12-B (RG lamp) may be disposed at a face 11-1 opposite to the face 11-2, substantially in parallel to the face 11-1 and therealong.

Alternatively, though not illustrated, the lamp 12-A (B lamp) and the lamp 12-B (RG lamp) may be disposed at either the face 11-1 or the face 11-2, in a direction substantially perpendicular to the face.

Although the back light device 1 is equipped with the two lamps 12-A (B lamp) and 12-B (RG lamp), the number of the lamps is not particularly restrictive.

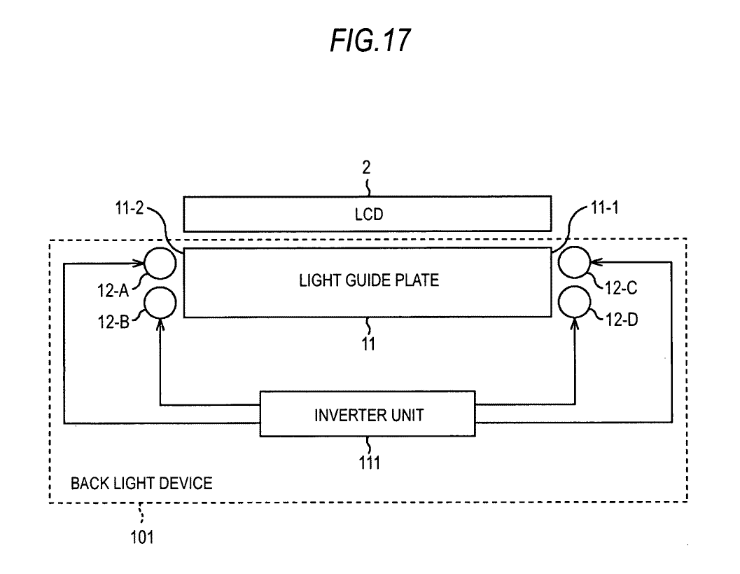

FIG. 17 is a cross-sectional view showing a further configurational example of a liquid crystal display apparatus used in a notebook type personal computer or the like as an embodiment of the display apparatus to which the invention is adapted, which is different from the examples shown in FIGS. 1 and 16.

A back light device 101 shown in FIG. 17 has four lamps 12-A to 12-D.

In the example in FIG. 17, the four lamps 12-A to 12-D are separated into a first set and a second set as follows. The first set includes two lamps 12-A and 12-B. The second set includes two lamps 12-C and 12-D. In this case, all the lamps belonging to the first set can be disposed on the face 11-2 side of the light guide plate 11, substantially in parallel to the face 11-2 and therealong. All the lamps belonging to the second set can be disposed on the face 11-1 side opposite to the face 11-2, substantially in parallel to the face 11-1 and therealong.

The layout positions of the four lamps 12-A to 12-D are not particularly limited to those shown in FIG. 17.

For example, though not illustrated, the lamp 12-A and the lamp 12-C may be used as the first set, and the lamp 12-B and the lamp 12-D may be used as the second set.

Further, though not illustrated, the layout positions corresponding to those in FIG. 1, for example, may be employed. That is, the all of the four lamps 12-A to 12-D may be disposed on the face 11-1 side of the light guide plate 11, substantially in parallel to the face 11-1 (along the face 11-1). In this case, any two of the lamps 12-A to 12-E can be used as the first set, while the remaining two can be used as the second set.

In this case, no matter which classification approach is employed, it is possible to use a set including only one of the B lamp and the RG lamp as the first set, and use a set including only the remaining lamp as the second set. This can facilitate the current ratio control of the invention.

The back light device which uses a lamp as a light source has been described above as the first embodiment of the lighting apparatus to which the invention is adapted. A back light device which uses an LED (Light Emitting Diode) as a light source will be described as the second embodiment of the lighting apparatus to which the invention is adapted.

### 2. Second Embodiment of the Lighting Apparatus to which the Invention is Adapted

### [Outline of the Related-Art Back Light Device Including LEDs as a Light Source]

To begin with, the outline of the related-art back light device including LEDs as a light source will be described for ease of understanding the second embodiment of the lighting apparatus to which the invention is adapted.

When one type of LED is used as a light source, naturally, it is possible to merely set one type of chromaticity (color temperature) for the display apparatus.

It is rare that a single LED constitutes a light source, and multiple LEDs constitute a light source. A variation in the chromaticity of the multiple LEDs directly appears as a variation in the chromaticity of the display apparatus.

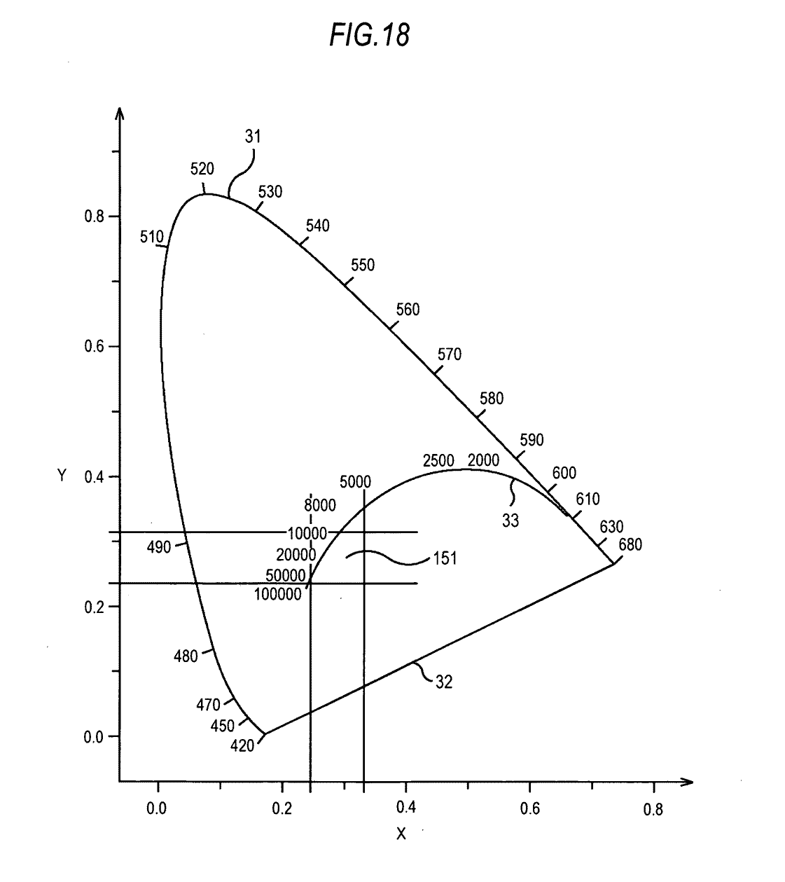

FIG. 18 is a general chromaticity diagram which is the same as the chromaticity diagrams in FIGS. 3 and 10.

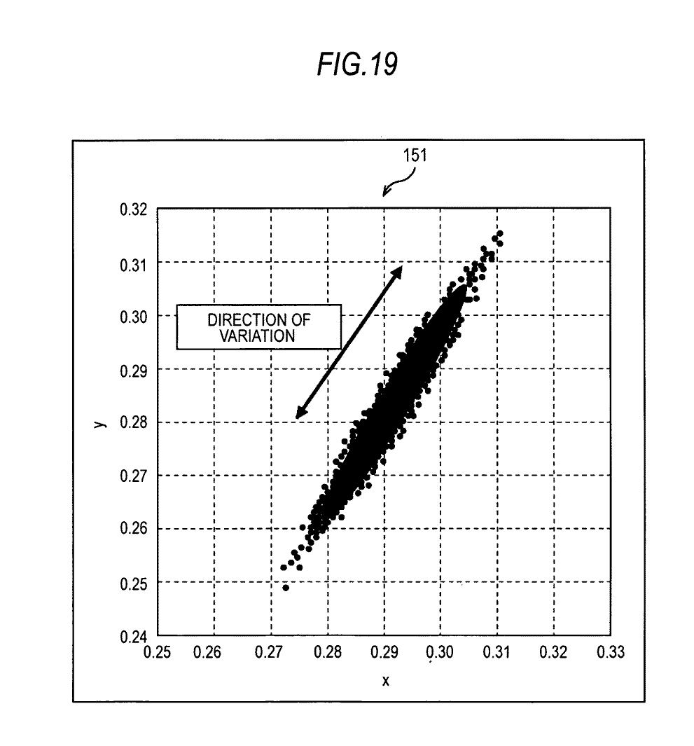

FIG. 19 is a diagram showing, in enlargement, an area 151 enclosed by a rectangle in the chromaticity diagram in FIG. 18.

FIG. 19 shows actual chromaticities of a plurality of white LEDs (each of which generally has a yellow phosphor applied to a blue semiconductor chip) plotted. Note that because there are many plots, the chromaticities are expressed in FIG. 19 as if they were a belt-like group of black points. The direction of such a black belt-like group is the direction of a variation in the chromaticities of the LEDs.

It is to be noted that the color coordinates of a single LED, like those of a lamp, differ from the color coordinates on the display apparatus.

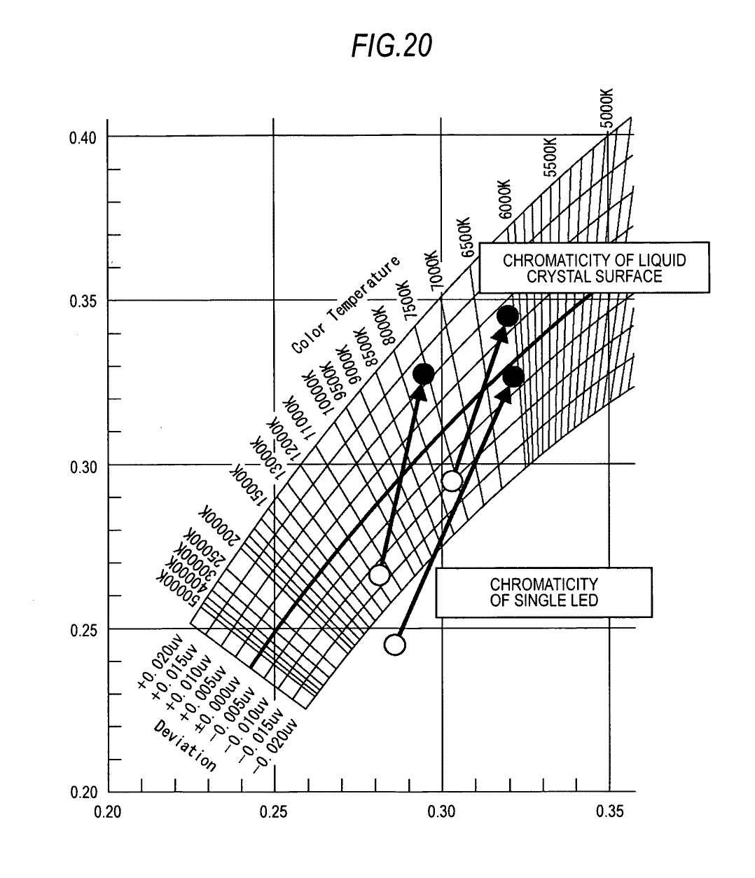

FIG. 20 is a diagram showing the degrees of changes in the color coordinates of a single LED and in the color coordinates of the liquid crystal surface.

As shown in FIG. 20, the chromaticity shifts from the chromaticity of a single LED to the chromaticity at the last liquid crystal surface. That is, as the light from a single LED travels through the back light device including the light guide plate and various sheets, and further travels through the color filters, polarizing plates and liquid crystal, the light is finally input to human eyes as a light (image) from the display apparatus. Accordingly, the chromaticity of a single LED differs from the chromaticity on the display apparatus.

The related-art current ratio variable control described in Patent Document 5 (the outline has already been described herein) can be used as the related-art back light device including LEDs as a light source. That is, the instead of the lamp 12-A, 12-B made by red, green and blue phosphors, two white LEDs, namely a white LED whose chromaticity is biased on the blue side and a white LED whose chromaticity is biased on the yellow side, are employed as a light source, thereby achieving the related-art current ratio variable control.

In this case, however, two types of white LEDs are used, a variation in a single LED which has been described using FIG. 19 occurs in each of the two types of LEDs, and the variations are combined, thus making the degree of the general variation greater. Because the two types of LEDs are basically while LEDs, the chromaticities of the individual LEDs are located relatively nearby in the chromaticity diagram. In changing the color temperature (chromaticity), therefore, the current ratio of the currents which are let to flow in the two types of LEDs becomes large. That is, the light source is merely changed to a while LED from a lamp, the above-described demerit of the related-art current ratio variable control naturally remains. In other words, even the use of the two types of white LEDs as a light source cannot realize the current ratio variable control of the invention.

In principle, the current ratio variable control of the invention can be realized by using three types of LEDs of red, green and blue.

However, LEDs of different colors are formed by semiconductor chips of different colors, respectively. When two types or three types of semiconductor chips of different colors are used to show white on the display apparatus, therefore, the characteristics of the individual semiconductor chips differ. For example, characteristics, such as the temperature characteristic, the current/voltage characteristic, the current/light intensity characteristic, and the aging-originated change, differ. In case of using a plurality of LEDs respectively formed by semiconductor chips of different color, therefore, the different characteristics need to be corrected.

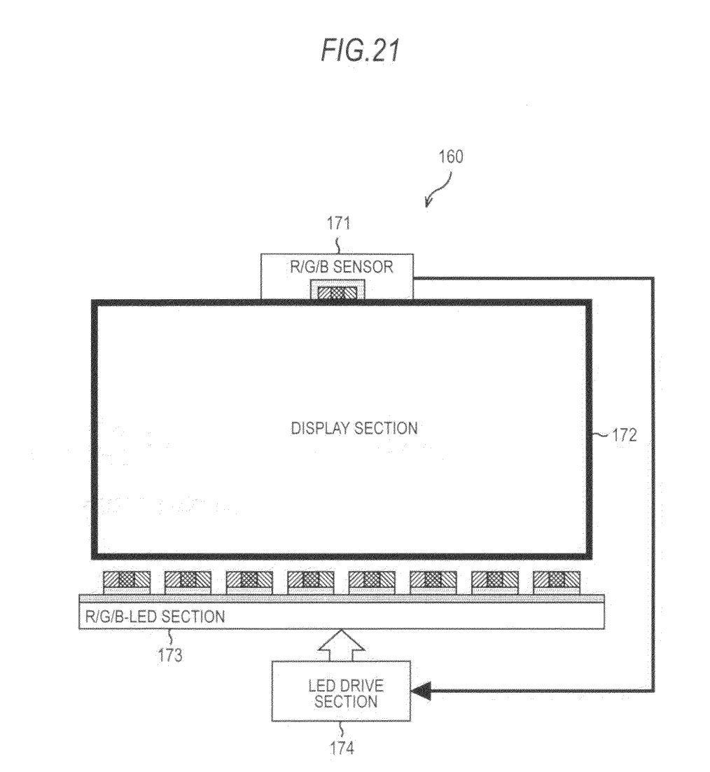

FIG. 21 is a diagram showing one example of the configuration of a display apparatus equipped with a back light device which uses three types of LEDs of red, green and blue as a light source.

The display apparatus exemplified in FIG. 21 is configured to include an R/G/B sensor 171, a display section 172, an R/G/B-LED section 173, and an LED drive section 174.

The R/G/B sensor 171 detects colors displayed on the display section 172 to correct/absorb the characteristics of the three types of LEDs of red, green and blue. The result of such detection is fed back as a feedback signal to the LED drive section 174 for each of the three types of LEDs of red, green and blue. The LED drive section 174 performs correction absorbing the differences in characteristics using the feedback signal before driving the R/G/B-LED section 173. The R/G/B-LED section 173 is configured to have plural sets of LEDs, each set having three types of LEDs of red, green and blue.

In this case, the circuit including the R/G/B sensor 171 and the R/G/B-LED section 173 becomes complex, and a structure for mounting the R/G/B sensor 171 is needed. Consequently, in case of realizing the display apparatus exemplified in FIG. 21, it is difficult to make the display apparatus compact. This does not change at all even if two types of LEDs, namely the blue LED and yellow LED, are used as a light source.

[Current Ratio Variable Control of the Invention when LEDs are a Light Source]

According to the second embodiment, therefore, the following LEDs are used as a light source of the back light device, so that the whole display apparatus can be made compact while achieving the current ratio variable control of the invention. Two or more types of LEDs with different chromaticities, each of which is formed by a blue semiconductor chip, are used. Specifically, a blue LED formed by a blue semiconductor chip is used as one type, and a “LED configured to having a phosphor applied to a blue semiconductor chip to emit light” is used as the other type(s). Hereinafter, the “LED configured to having a phosphor applied to a blue semiconductor chip to emit light” is called “blue semiconductor chip+phosphor-based LED”.

The following will describe a back light device using one type of blue LED and one type of “LED configured to having a phosphor applied to a blue semiconductor chip to emit light” as a specific example.

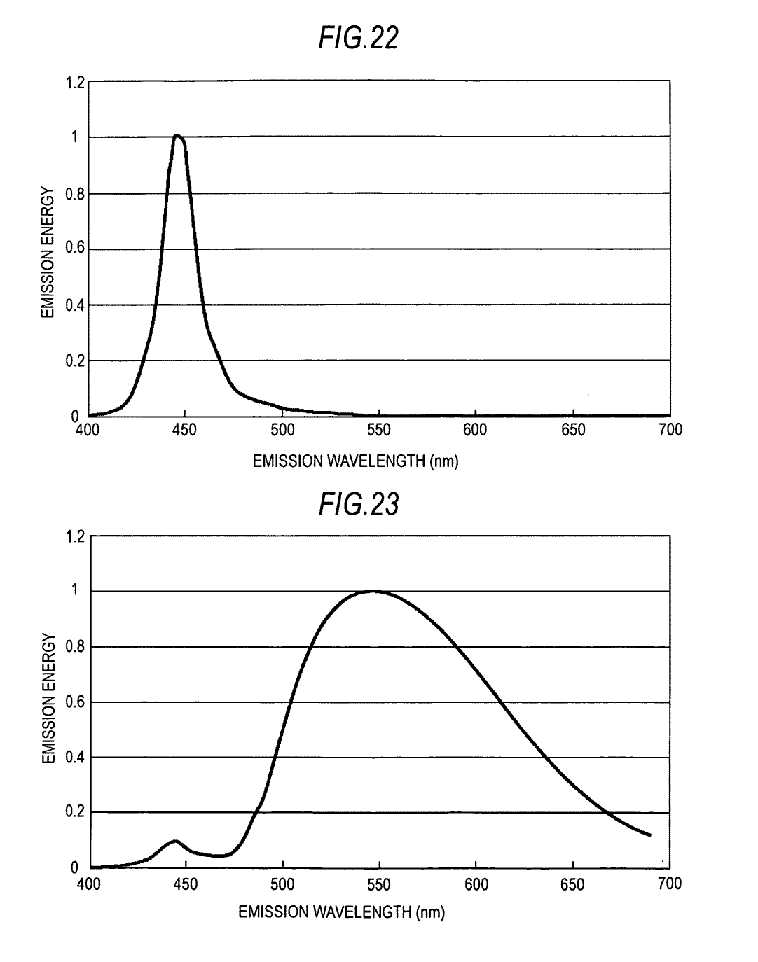

FIG. 22 shows an example of the emission spectrum of a blue LED. The spectrum shown in FIG. 22 can be said to be the emission spectrum of the blue semiconductor chip itself.

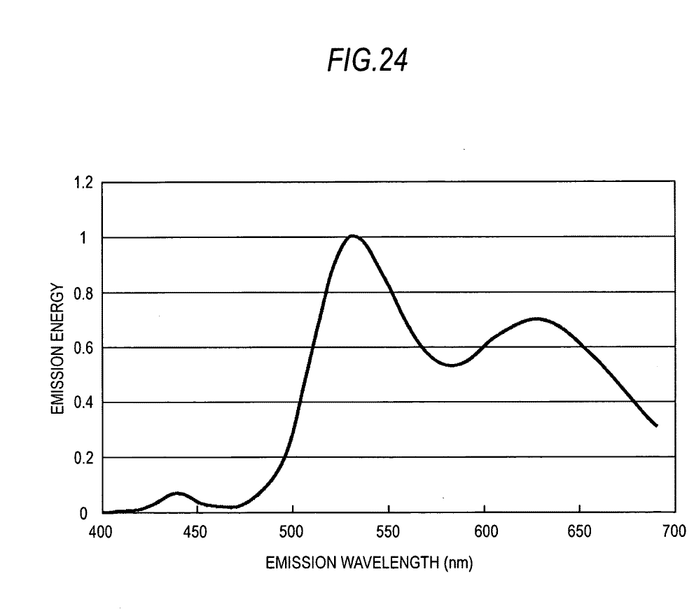

FIGS. 23 and 24 respectively show two examples of the emission spectrum of the “blue semiconductor chip+phosphor-based LED”.

The emission spectrum exemplified in FIG. 23 is formed by blending the emission spectrum of a blue semiconductor chip with a wavelength of about 450 nm and the spectrum of a yellow phosphor which emits light when excited by a light energy of about 450 nm. Hereinafter, the former spectrum in the two spectra is called the spectrum of the blue portion, and the latter spectrum is called the spectrum of the yellow portion. The degrees of the levels of the spectra of the blue portion and the yellow portion are adjusted by the dispense amount of the yellow phosphor. That is, although the spectrum is projecting upward at about 550 nm in the example in FIG. 23, the shape can be changed freely by the dispense amount. In other words, the chromaticity of the “blue semiconductor chip+phosphor-based LED” is decided by the dispense amount of the yellow phosphor.

The emission spectrum exemplified in FIG. 24 is formed by blending the emission spectrum of a blue semiconductor chip with a wavelength of about 450 nm, the spectrum of a green phosphor which emits light when excited by a light energy of about 450 nm, and the spectrum of a red phosphor which emits light when excited by a light energy of about 450 nm. Hereinafter, the first spectrum in the three spectra is called the spectrum of the blue portion, while a spectrum obtained by blending the second and third spectra is called the spectrum of the yellow portion. The degrees of the levels of the spectra of the blue portion and the yellow portion are adjusted by the dispense amounts of the green phosphor and the red phosphor. That is, although the spectrum is projecting upward at about 540 nm and about 630 nm in the example in FIG. 24, the shape can be changed freely by the dispense amounts. In other words, the chromaticity of the “blue semiconductor chip+phosphor-based LED” is decided by the dispense amounts of the green phosphor and the red phosphor.

While the example in FIG. 24 has a better color reproducibility than the example in FIG. 23 for the green spectrum and the red spectrum are separated, the luminance efficiency is reduced. Therefore, it is desirable to use, as the “blue semiconductor chip+phosphor-based LED”, the example in FIG. 23 in case of preferring the luminance, and the example in FIG. 24 in case of preferring the color reproduction.

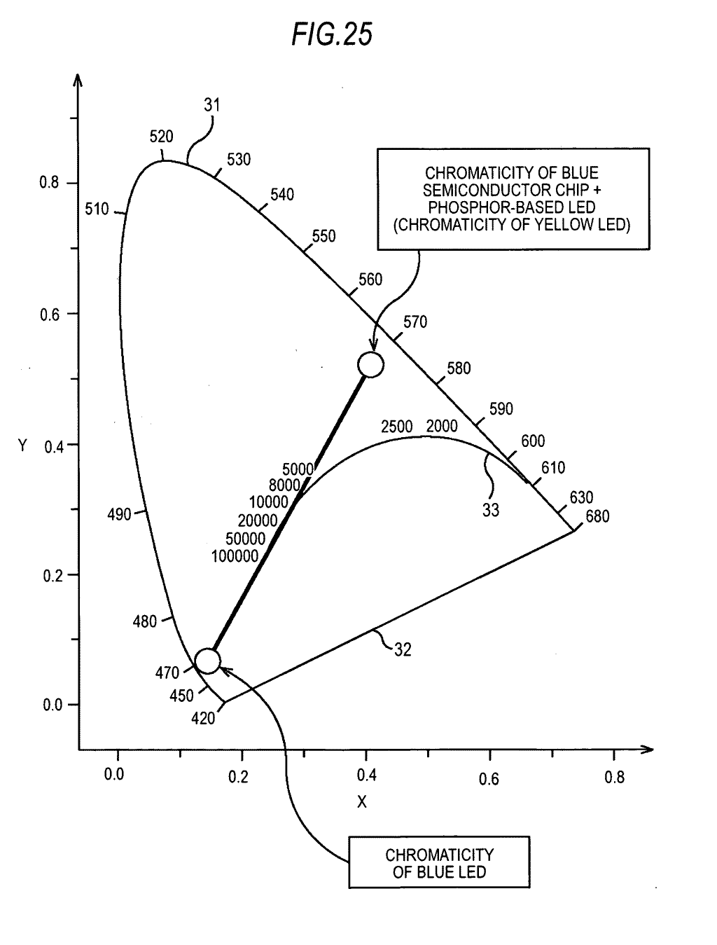

FIG. 25 is a chromaticity diagram for explaining the current ratio variable control of the invention when the light source is an LED.

The chromaticity diagram in FIG. 25 itself is the same as the chromaticity diagram in FIG. 10, for example.

In the current ratio variable control of the invention exemplified in FIG. 25, as in the example in FIG. 10, the color coordinates can be set according to the current ratio within the range of a line connecting the individual chromaticities by changing the current ratio of the blue LED and the “LED configured to having a phosphor applied to a blue semiconductor chip to emit light”.

As shown in FIG. 25, the chromaticity of the “LED configured to having a phosphor applied to a blue semiconductor chip to emit light” is a yellow chromaticity. Accordingly, the “LED configured to having a phosphor applied to a blue semiconductor chip to emit light” is hereinafter called “yellow LED”.

Such a blue LED has a variation originating from the emission spectrum of the blue semiconductor chip (hereinafter called “blue-originated variation”). The yellow LED however has a variation originating from the dispense amount of the phosphor applied to the blue semiconductor chip (hereinafter called “phosphor-originated variation”). The degree of the blue-originated variation is small, whereas the degree of the phosphor-originated variation is large. However, the direction of the phosphor-originated variation is basically the direction of the line connecting the chromaticity of the blue LED and the chromaticity of the yellow LED as shown in FIG. 25 (direction shown in FIG. 19). Even if there is a variation in the yellow LED caused by the phosphor-originated variation, therefore, the variation can be absorbed by adjusting the currents of the blue LED and the yellow LED.

The line connecting the chromaticity of the blue LED and the chromaticity of the yellow LED as shown in FIG. 25 extends substantially along the black body curve 33 where the color temperature is in the vicinity of the range of about 6500K to 18000K. In other words, the chromaticity of the blue LED and the chromaticity of the yellow LED are set in such a way as to lie along the black body curve 33.

Therefore, for example, a plurality of points, 5000K, 6500K, 95000K, 12000K, and so forth, can be set as the chromaticities of a light output from the light guide plate 11 or the chromaticity coordinates of the chromaticity of a light output from the LCD 2. For example, let us consider the case of setting 6500K for comparison with what is shown in FIG. 3. In this case, according to the current ratio variable control of the invention exemplified in FIG. 25, the inverse ratio of the linear distance between the chromaticity of the blue LED and 6500K and the linear distance between the chromaticity of the yellow LED and 6500K can be set as the current ratio of the blue LED and the yellow LED in the chromaticity diagram in FIG. 25. In this case, the linear distance between the chromaticity of the blue LED and 6500K and the linear distance between the chromaticity of the yellow LED and 6500K (see the chromaticity diagram in FIG. 25) is considerably longer than the linear distance in the related art (see the chromaticity diagram in FIG. 3). Therefore, the current ratio that is settable in the current ratio variable control of the invention exemplified in FIG. 25, namely the current ratio variable control of the invention when the light source is an LED, can be made smaller the current ratio that is settable in the related-art current ratio variable control. As a result, the use of the current ratio variable control of the invention exemplified in FIG. 25 (light source is an LED) can demonstrate an effect similar to the effect of the current ratio variable control of the invention exemplified in FIG. 10 (light source is a lamp).

Because the blue LED and the yellow LED are each formed by a blue semiconductor chip, the characteristics of the voltage, current, temperature, etc. are the same for both LEDs. That is, the LEDs of the individual colors which constitute the R/G/B-LED section 173 in FIG. 21 have different semiconductor chips which emit the respective lights, and differ in the individual characteristics, so that the feedback control circuit or the like becomes complex. However, the current ratio variable control of the invention if achieved by using the blue LED and yellow LED eliminates the need for such a complicated circuit, so that the overall display apparatus can be made compact.

### [Configuration Example of the Back Light Device as the First Embodiment of the Lighting Apparatus]

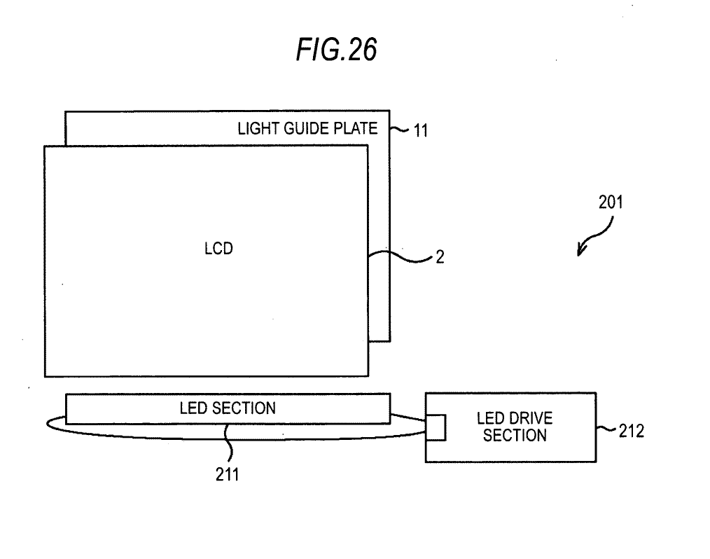

FIG. 26 is a diagram showing another configurational example of a liquid crystal display apparatus used in a notebook type personal computer or the like as the second embodiment of the display apparatus to which the invention is adapted, when LEDs are used as a light source of the back light device.

The liquid crystal display apparatus exemplified in FIG. 26 is provided with a back light device 201 and LCD 2.

The back light device 201 is provided with a light guide plate 11, an LED section 211 and an LED drive section 212.

The light guide plate 11 is disposed on the back side of the LCD 2 (the surface shown in FIG. 26 is the display surface of the LCD 2, which is the top surface), so that the light incoming from the LED section 211 is output toward the LCD 2 (in a predetermined direction).

A diffusion sheet, a prism sheet, etc. may be disposed between the top side of the light guide plate 11 (side facing the back side of the LCD 2) and the back side of the LCD 2. In addition, a reflective sheet or the like may be disposed on the back side of the light guide plate 11.

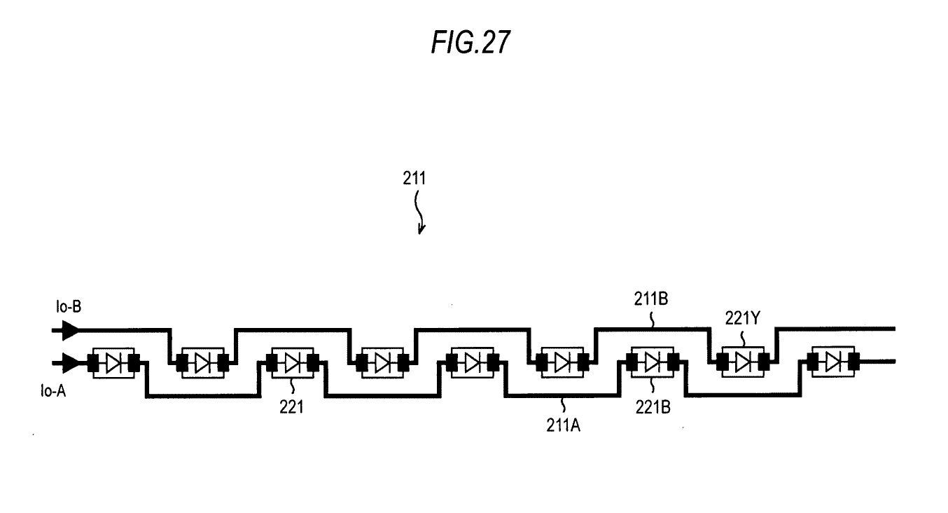

FIG. 27 shows an example of the configuration of the LED section 211 including a blue LED and a yellow LED.

The LED section 211 includes an LED group 211A having a plurality of blue LEDs 221B electrically connected in series, and an LED group 211B having a plurality of yellow LEDs 221Y electrically connected in series. The blue LEDs 221B and the yellow LEDs 221Y are spatially laid out alternately in a so-called crossed belting layout. Naturally, the spatial layout of the blue LEDs 221B and the yellow LEDs 221Y is not restricted to the example in FIG. 27.

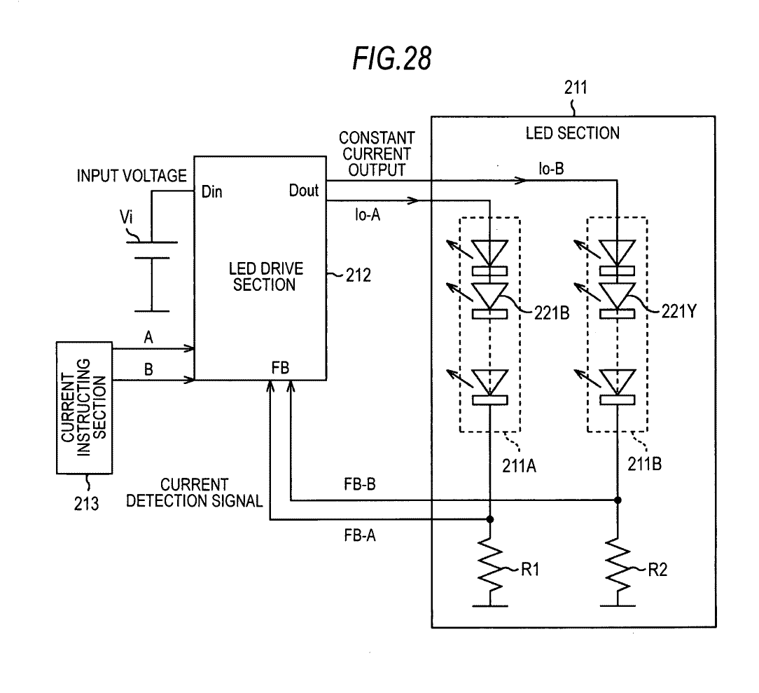

FIG. 28 shows an example of the configuration of the LED section 211 and the LED drive section 212.

The LED drive section 212 has two outputs. The first one of the two outputs is connected to the LED group 211A, and the second output is connected to the LED group 211B. That is, the LED drive section 212 can individually drive the LED group 211A and the LED group 211B. Specifically, the LED drive section 212 can individually output a constant current Io-A for the LED group 211A and a constant current Io-B for the LED group 211B from an input voltage Vi. To maintain the constant current Io-A, a current detection signal FB-A of the LED group 211A is fed back by a current detection resistor R1. Likewise, to maintain the constant current Io-B, a current detection signal FB-B of the LED group 211B is fed back by a current detection resistor R2. The size of the constant current Io-A is variably controlled by an individual control signal A from a current instructing section 213. Likewise, the size of the constant current Io-B is variably controlled by an individual control signal B from the current instructing section 213. That is, as the individual control signal A and the individual control signal B are independently supplied from the current instructing section 213, variable control of the constant current Io-A and variable control of the constant current Io-B can be independently carried out.

In other words, “B lamp” can be replaced with “LED group 211A”, and “RG lamp” can be replaced with “LED group 211B” in the current instruction control process in FIG. 15. This can allow the control part in the back light device 201 which includes the LED drive section 212 and the current instructing section 213 can execute the current instruction control process in FIG. 15 directly.

The LEDs which are provided in the LED section 211 of the back light device 201 can be LEDs available in making the overall display apparatus compact in achieving the current ratio variable control of the invention, and are not restricted to those in the foregoing example.

For example, three types of LEDs, namely a blue LED, “blue semiconductor chip+green-phosphor-based green LED” and “blue semiconductor chip+red-phosphor-based red LED”, can be used as light sources of the back light device. The “blue semiconductor chip+green-phosphor-based green LED” is called “green LED” and the “blue semiconductor chip+red-phosphor-based red LED” is called “red LED” hereinafter. Provided that the green LED and the red LED are grouped as one set, the set can be grasped as a yellow LED. That is, the blue LED, the red LED and the green LED can be used as another example of the blue LED and the yellow LED.

Because the blue LED, the green LED and the red LED are each formed by the same blue semiconductor chip, the characteristics of the voltage, current, temperature, etc. are the same for both LEDs. That is, the LEDs of the individual colors which constitute the R/G/B-LED section 173 in FIG. 21 have different semiconductor chips which emit the respective lights, and differ in the individual characteristics, so that the feedback control circuit or the like becomes complex. However, the current ratio variable control of the invention, if achieved by using the three types of LEDs which are formed by the blue semiconductor chip eliminates the need for such a complicated circuit, so that the overall display apparatus can be made compact.

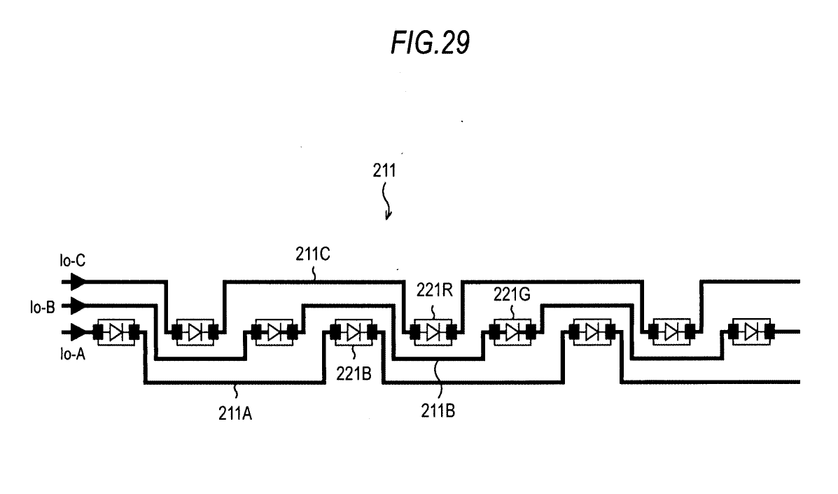

FIG. 29 shows an example of the configuration of the LED section 211 including three types of LEDs, namely a blue LED, a green LED and a red LED.

The LED section 211 includes an LED group 211A having a plurality of blue LEDs 221B electrically connected in series, an LED group 211C having a plurality of red LEDs 221R electrically connected in series, and an LED group 211B having a plurality of green LEDs 221G electrically connected in series. The blue LEDs 221B, the red LEDs 221R and the green LEDs 221G are spatially laid out alternately in a so-called crossed belting layout. Naturally, the spatial layout of the blue LEDs 221B, the red LEDs 221R and the green LEDs 221G is not restricted to the example in FIG. 29.

In this case, though not illustrated, it is necessary to configure the LED drive section 212 in such a way as to independently execute the variable control of the constant current Io-A, variable control of the constant current Io-B and variable control of the constant current Io-C.

The back light device using LEDs as light sources has been described as the second embodiment.

LEDs are not particularly limited as long as they can achieve the current ratio variable control of the invention. For example, two types of LEDS among three types of LEDs of red, green and blue may be formed by a blue semiconductor chip, while the remaining one type of LEDs may be formed by a monochromatic semiconductor chip.

It is however favorable that all the types of LEDs are formed by a blue semiconductor chip. This is because the current control and the like can be achieved by a simple and concise configuration.

In case of using plural types of LEDs formed by semiconductor chips of different colors, respectively, as in the example in FIG. 21, for example, the plural types of LEDs differ in their characteristics, making the current control or the like complicated, and also differ in aging-originated change, thus making it complex to handle the LEDs. By way of contrast, the use of plural types of LEDs formed by a blue semiconductor chip makes the basic characteristics of the LEDs identical and can achieve current control or the like with a simple and easy structure.

Further, it is favorable to use a blue LED and a yellow LED as plural types of LEDs formed by a blue semiconductor chip. This is because a variation (error) in chromaticity of the display apparatus can be absorbed by adjustment.

That is, while the blue LED has a relatively small variation in color coordinates of the chromaticity, the yellow LED has a larger variation in color coordinates of the chromaticity caused by the amount of the phosphor. Because the variation occurs mainly on the blue and yellow sides, however, the variation can be absorbed by adjusting the light quantity (current) of at least one of the blue LED and the yellow LED. As a result, the display apparatus can make the variation smaller.

In case of using two types of white LEDs with different chromaticities, variations of the white LEDs occur in the same direction, but differ type by type. In other words, there are two types of variations, so that multiplication of the two types of variations increases the degree of the final variation. In case of using the blue LED and the yellow LED, by way of contrast, the main variation depends significantly on the variation of the yellow LED, so that the degree of the variation of the yellow LED alone should be suppressed. This simplifies the management.

From the viewpoint of current ratio variable control, in case of using two types of white LEDs, the color coordinates of the chromaticities of the two types of white LEDs are close to each other, making it necessary to set a large current difference between the two types of LEDs in setting the color temperature (chromaticity), as mentioned above. The large current difference causes various demerits as described above referring to FIGS. 4 and 5. In case of using the blue LED and the yellow LED, on the other hand, the color coordinates of the chromaticity of the blue LED are set apart from the color coordinates of the chromaticity of the yellow LED. In setting the color temperature (chromaticity), therefore, the intended color temperature can be set easily without providing a large current difference between the two types of LEDs. That is, the aforementioned various demerits can be overcome. For example, because the maximum current which can flow in the LEDs is decided, a smaller current difference between the two types of LEDs settable means that the total current can be set large, or the luminance of the overall display apparatus can be improved.

Note that while the above-described sequence of processes can be executed by hardware, it can also executed by software.

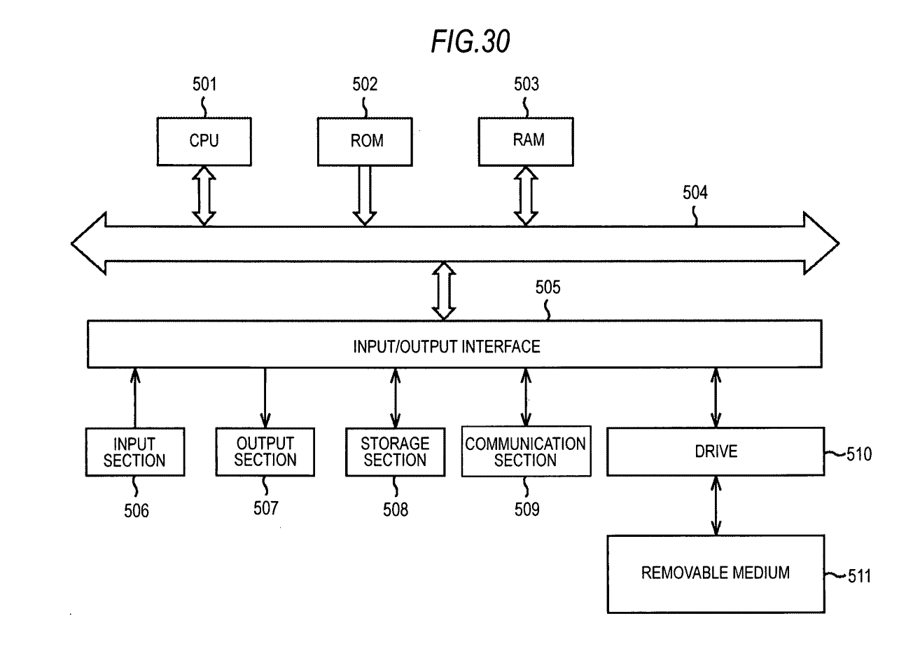

In case of executing the sequence of processes on the software basis, a program constituting the software is installed, over a network or from a recording medium, in a computer provided in dedicated hardware (e.g., the current instructing section 21 or the like of the inverter unit 13 in FIG. 2), or a general-purpose computer or the like shown in FIG. 30 which can execute various functions when various corresponding programs are installed therein.

Referring to FIG. 30, a CPU 501 executes various processes according to programs stored in an ROM 502 or programs loaded into an RAM 503 from a storage section 508. Further, data or the like necessary for the CPU 501 to execute various processes is also stored in the RAM 503 as needed.

The CPU 501, the ROM 502 and the RAM 503 are interconnected by a bus 504. The bus 504 is connected with an input/output interface 505.

The input/output interface 505 is further connected with an input section 506 including a keyboard and a mouse, an output section 507 having a display or the like, the storage section 508, and a communication section 509 including a modem and a terminal adaptor.

In this case, the output section 507 can be configured as, for example, a display apparatus (including at least the back light device 1 and LCD 2) as shown in FIG. 1, or a display apparatus (including at least the back light device 201 and LCD 2) as shown in FIG. 26. In this case, the above-described sequence of processes for the output section 507 is executed by the CPU 501.

The input/output interface 505 is connected with a drive 510 as needed, in which a removable recording medium 511, such as a magnetic disk, optical disc, magneto optical disc, or semiconductor memory, is mounted when proper, so that a computer program read from the removable recording medium 511 is installed in the storage section 508 as needed.

The recording medium containing such a program is formed not only as the removable recording medium (package medium) 511 configured by a program-recorded magnetic disk (including a floppy disk), optical disc (including a CD-ROM (Compact Disc-Read Only Memory), DVD (Digital Versatile Disc)), magneto optical disc (including an MD (Mini-Disc)), or semiconductor memory, which is distributed to provide a user with the program, but also the program-stored ROM 502 and a hard disk included in the storage section 508, which are pre-installed in the apparatus body to be provided to the user.

The term “system” used herein represents the entire apparatus which includes a plurality of devices and processing sections.

In addition, steps describing a program to be stored in the recording medium include processes which are carried out on the time-sequential basis in order, or processes which are carried out not, necessarily on the time-sequential basis, but in parallel or individually.

The present application contains subject matter related to that disclosed in Japanese Priority Patent Application JP 2008-326994 filed in the Japan Patent Office on Dec. 24, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A lighting apparatus comprising:
a first light source having a predetermined chromaticity in a chromaticity diagram and an emission luminance which varies according to a current;
a second light source configured in such a way that a line connecting the chromaticity of the first light source and a chromaticity of the second light source in the chromaticity diagram passes a part of a black body curve, and having an emission luminance which varies according to a current;
a light guide plate that outputs lights from the first light source and the second light source in a predetermined direction; and
a light source drive section that fixes a current of one of the first light source and the second light source and variably controls a current of the other one of the first light source and the second light source according to a target value of a chromaticity of a combined light of the lights output from the light guide plate.

2. The lighting apparatus according to claim 1, wherein each of the first light source and the second light source is configured to include a lamp.

3. The lighting apparatus according to claim 2, wherein the first light source is configured to include a lamp formed of a blue phosphor.

4. The lighting apparatus according to claim 3, wherein the second light source is configured to include a lamp formed of a green phosphor and a red phosphor.

5. The lighting apparatus according to claim 4, wherein the light source drive section fixes the current of the second light source, and variably controls the current of the first light source.

6. The lighting apparatus according to claim 1, wherein the light source drive section
controls the currents of the first light source and the second light source so as to become a predetermined level when a predetermined color coordinate is set as a target value within a range of color coordinates settable as a target value of the chromaticity,
fixes the current of one of the first light source and the second light source to the predetermined level, and variably controls the current of the other one of the first light source and the second light source in a range lower than the predetermined level, when a color coordinate lower than the predetermined color coordinate is set as the target value, and
variably controls the current of the one of the first light source and the second light source in a range lower than the predetermined level, and fixes the current of the other one of the first light source and the second light source to the predetermined level, when a color coordinate higher than the predetermined color coordinate is set as the target value.

7. The lighting apparatus according to claim 1, wherein the line connecting the chromaticity of the first light source in the chromaticity diagram passes a color temperature of 6500K in the chromaticity diagram or within a predetermined range.

8. The lighting apparatus according to claim 1, wherein the first light source includes an LED (Light Emitting Diode) having a blue semiconductor chip, and
the second light source includes an LED having a phosphor applied to a blue semiconductor chip to emit light.

9. A lighting method of a lighting apparatus including a first light source having a predetermined chromaticity in a chromaticity diagram and an emission luminance varying according to a current, a second light source configured in such a way that a line connecting the chromaticity of the first light source and a chromaticity of the second light source in the chromaticity diagram passes a part of a black body curve, and having an emission luminance which varies according to a current, and a light guide plate outputting lights from the first light source and the second light source in a predetermined direction, the method comprising the step of:
allowing the lighting apparatus to drive the first light source and the second light source and to fix a current of one of the first light source and the second light source and to variably control a current of the other one of the first light source and the second light source according to a target value of a chromaticity of a combined light of the lights output from the light guide plate.

10. A display apparatus comprising:
a first light source having a predetermined chromaticity in a chromaticity diagram and an emission luminance which varies according to a current;
a second light source configured in such a way that a line connecting the chromaticity of the first light source and a chromaticity of the second light source in the chromaticity diagram passes a part of a black body curve, and having an emission luminance which varies according to a current;
a light guide plate that outputs lights from the first light source and the second light source in a predetermined direction;
a display panel that uses the lights incoming from the light guide plate to display an image; and
a light source drive section that drives the first light source and the second light source and fixes a current of one of the first light source and the second light source and variably controls a current of the other one of the first light source and the second light source according to a target value of a chromaticity of a combined light of the lights output from the light guide plate.

11. A display method of a display apparatus including a first light source having a predetermined chromaticity in a chromaticity diagram and an emission luminance varying according to a current, a second light source configured in such a way that a line connecting the chromaticity of the first light source and a chromaticity of the second light source in the chromaticity diagram passes a part of a black body curve, and having an emission luminance which varies according to a current, a light guide plate outputting lights from the first light source and the second light source in a predetermined direction, and a display panel using the lights incoming from the light guide plate to display an image, the method comprising the step of:
allowing the display apparatus to drive the first light source and the second light source and to fix a current of one of the first light source and the second light source and to variably control a current of the other one of the first light source and the second light source according to a target value of a chromaticity of a combined light of the lights output from the light guide plate.
